(19) United States
(12) Patent Application Publication
(10) Pub. No.: US 2026/0257219 A1
(43) Pub. Date: Sep. 3, 2026

(54) FLUIDIC DEVICE

(71) Applicant: KYOCERA Corporation, Kyoto-shi, Kyoto (JP)

(72) Inventor: Yu AOYAGI, Higashiomi-shi, Shiga (JP)

(21) Appl. No.: 19/159,615

(22) PCT Filed: Feb. 16, 2024
(86) PCT No.: PCT/JP2024/005531

§ 371 Date: Aug. 26, 2025

(30) Foreign Application Priority Data
Feb. 27, 2023 (JP) 2023-028463

(51) Int. Cl. B01L 3/00

(52) U.S. Cl. CPC B01L 3/502715; B01L 2200/027; B01L 2300/0809

(57) ABSTRACT

A fluidic device includes a first fluidic channel, second fluidic channels, third to fifth fluidic channels, and a first outlet hole. The first fluidic channel includes a first upstream portion and a first downstream portion, and extends in a first direction. The second fluidic channels are connected to a surface of the first fluidic channel located in a second direction intersecting the first direction, between the first upstream portion and the first downstream portion. The third fluidic channel is connected to the first downstream portion. The fourth fluidic channel and the fifth fluidic channel are connected to the first upstream portion. The first outlet hole is connected to a second downstream portion of the third fluidic channel. The first fluidic channel, the second fluidic channels, and the third to fifth fluidic channels are formed between two plate-like portions. The third fluidic channel includes one or more wide portions.

### CROSS-REFERENCE TO RELATED APPLICATION

The present application is a National Phase of International Application No. PCT/JP2024/005531 filed Feb. 16, 2024, which claims priority to Japanese Patent Application No. 2023-028463 filed on Feb. 27, 2023, the entire disclosure of which is incorporated herein by reference.

### FIELD

The present disclosure relates to a fluidic device and a measurement apparatus.

### BACKGROUND

A known fluidic device (refer to, for example, Japanese Patent No. 6955126) includes a sorting fluidic channel for sorting and extracting multiple particles of a specific type from multiple particles of another type in a liquid containing multiple types of particles and a measurement fluidic channel for measuring the multiple particles of the specific type extracted through the sorting fluidic channel with an optical sensor. A known measurement apparatus (refer to, for example, Japanese Patent No. 6955126) includes the fluidic device and the optical sensor.

A known microchip (refer to, for example, Japanese Unexamined Patent Application Publication (Translation of PCT Application) No. 2008-537146) includes a bending channel structure as a measurement fluidic channel used for optical detection.

A fluidic device and a measurement apparatus including a fluidic device are increasingly expected to have improved accuracy in optically measuring multiple particles flowing through a fluidic channel in the fluidic device.

### SUMMARY

A fluidic device is described.

In one aspect, a fluidic device includes a first fluidic channel, a plurality of second fluidic channels, a third fluidic channel, a fourth fluidic channel, a fifth fluidic channel, and a first outlet hole. The first fluidic channel includes a first upstream portion and a first downstream portion, and extends in a first direction. The plurality of second fluidic channels are connected to a surface of the first fluidic channel between the first upstream portion and the first downstream portion, the surface being located in a second direction intersecting the first direction in the first fluidic channel. The third fluidic channel is connected to the first downstream portion. The fourth fluidic channel is connected to the first upstream portion. The fifth fluidic channel is connected to the first upstream portion. The first outlet hole is connected to a second downstream portion of the third fluidic channel. The first fluidic channel, the plurality of second fluidic channels, the third fluidic channel, the fourth fluidic channel, and the fifth fluidic channel are formed between two plate-like portions. The third fluidic channel includes one or more wide portions between a portion connected to the first downstream portion and the second downstream portion.

### BRIEF DESCRIPTION OF THE DRAWINGS

FIG. 1 is a schematic plan view of a fluidic device according to a first embodiment, illustrating an example structure.

FIG. 2 is a schematic front view of the fluidic device according to the first embodiment, illustrating an example structure.

FIG. 3 is a schematic plan view of a fluidic channel section and multiple holes in the fluidic device, illustrating example structures.

FIG. 4 is a plan view of rectangular area IV defined by a dot-dash line in FIG. 3.

FIG. 5 is a plan view of rectangular area V defined by a dot-dash line in FIG. 3.

FIG. 6 is a schematic plan view of an example of multiple first particles flowing in an area of the fluidic channel section extending over a first downstream portion of a main fluidic channel and an upstream portion of a first channel portion of a measurement fluidic channel.

FIG. 7 is a schematic plan view of an example of multiple first particles flowing in an area of the measurement fluidic channel extending over a downstream portion of the first channel portion and an upstream portion of a second channel portion.

FIG. 8 is a schematic plan view of an example of multiple first particles flowing in an area of the measurement fluidic channel extending over a third area of the second channel portion and a fourth area of a third channel portion.

FIG. 9 is a conceptual diagram describing the loss of liquid pressure resulting from an increased cross-sectional area of a fluidic channel.

FIG. 10 is a schematic diagram of a measurement apparatus, illustrating an example structure.

FIG. 11 is a schematic plan view of a measurement fluidic channel in a reference example of the measurement apparatus.

FIG. 12 is a graph showing a specific example of a calibration curve and a reference example of the calibration curve.

FIG. 13 is a schematic plan view illustrating the position of a measurement area defined for a measurement fluidic channel in a specific example of the measurement apparatus.

FIG. 14 is a schematic plan view illustrating the position of a measurement area defined for a measurement fluidic channel in the reference example of the measurement apparatus.

FIG. 15 is a graph showing an example relationship between the intensity of light detected by an optical sensor and the number of measurements when the reference example of the measurement apparatus is used.

FIG. 16 is a graph showing an example relationship between the intensity of light detected by the optical sensor and the number of measurements when the specific example of the measurement apparatus is used.

FIG. 17 is a schematic plan view illustrating an example position of a measurement area for the measurement fluidic channel.

FIG. 18 is a schematic plan view of a fluidic channel section and multiple holes in a fluidic device in the reference example, illustrating an example structure.

FIG. 19 is a schematic plan view of a measurement fluidic channel in the fluidic channel section in the reference example, illustrating an example structure.

### DETAILED DESCRIPTION

A fluidic device includes a fluidic channel (also referred to as a sorting fluidic channel) for sorting and extracting multiple particles of a specific type from multiple particles of another type in a liquid (also referred to as a sample) containing multiple types of particles and a fluidic channel (also referred to as a measurement fluidic channel) for measuring the multiple particles of the specific type extracted through the sorting fluidic channel with an optical sensor. A measurement apparatus includes the fluidic device and the optical sensor.

The above fluidic device may be, for example, a single plate-like fluidic device including the sorting fluidic channel and the measurement fluidic channel arranged in a single plane. This structure may simplify the manufacturing processes of the fluidic device.

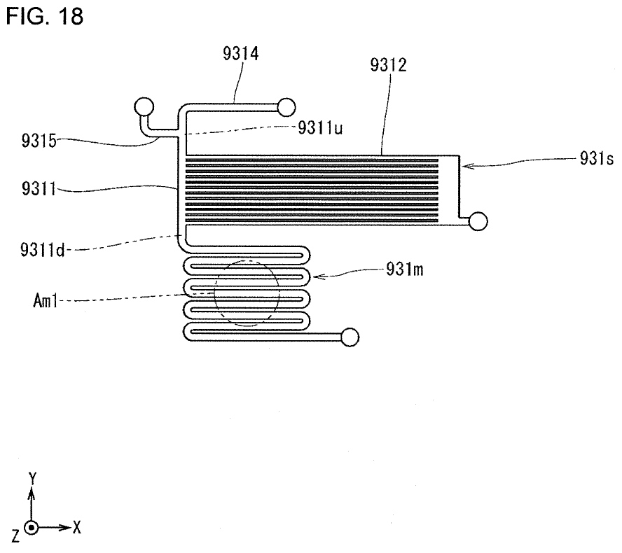

For example, as illustrated in FIG. 18, a fluidic channel used as a sorting fluidic channel 931s may include, for example, a main fluidic channel 9311 extending in a negative Y-direction, a feeding fluidic channel 9314 connected to a portion 9311u upstream of the main fluidic channel 9311 in a positive Y-direction, multiple microfluidic channels (also referred to as branch fluidic channels) 9312 branching from a side surface (also referred to as a first side surface) of the main fluidic channel 9311 located in a positive X-direction perpendicular to a longitudinal direction, and a fluidic channel (also referred to as a pushing fluidic channel) 9315 connected to the portion 9311u upstream of the main fluidic channel 9311 at a side surface (also referred to as a second side surface) located in a negative X-direction. In this case, when the sample is fed through the feeding fluidic channel 9314 to the portion 9311u upstream of the main fluidic channel 9311 with a liquid being fed through the pushing fluidic channel 9315 to the portion 9311u upstream of the main fluidic channel 9311, the sample flows from the portion 9311u upstream of the main fluidic channel 9311 to a portion 9311d downstream of the main fluidic channel 9311 with the multiple types of particles contained in the sample being pushed against the first side surface of the main fluidic channel 9311 located in the positive X-direction. Among the multiple types of particles, multiple particles of a type smaller than the width of the branch fluidic channels 9312 flow into the respective multiple branch fluidic channels 9312. Among the multiple types of particles, multiple particles (also referred to as first particles) P100 of a specific type larger than the width of the branch fluidic channels 9312 flow toward the portion 9311d downstream of the main fluidic channel 9311. Note that a particle smaller than the width of the branch fluidic channels 9312 may have the center of gravity located inside the respective branch fluidic channels 9312. The particle is thus also sufficiently small to enter the branch fluidic channels 9312. A particle larger than the width of the branch fluidic channels 9312 does not have the center of gravity inside the respective branch fluidic channels 9312 (the center of gravity is located outside the respective branch fluidic channels 9312). The particle is thus also sufficiently large not to enter the branch fluidic channels 9312. The sorting fluidic channel 931s can thus sort a liquid containing the multiple first particles P100 and a liquid containing the multiple particles of another type from the sample containing multiple types of particles, and can feed the liquid containing the multiple first particles P100 to the measurement fluidic channel 931m through the portion 9311d downstream of the main fluidic channel 9311.

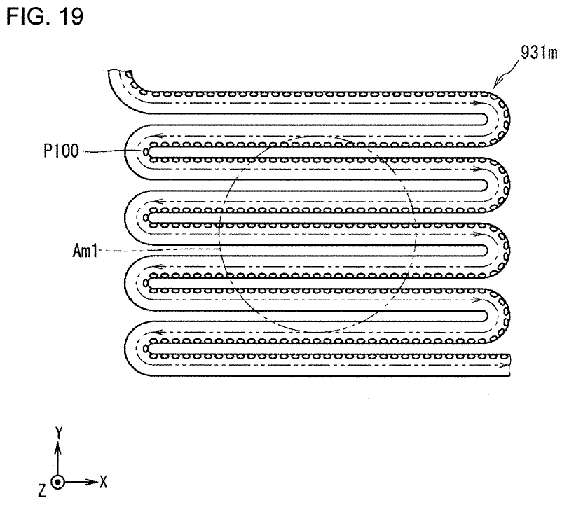

For example, as illustrated in FIGS. 18 and 19, the measurement fluidic channel 931m may be a bending fluidic channel. This structure may improve the accuracy in measuring the multiple first particles P100 with the optical sensor. In FIGS. 18 and 19, the circle illustrated with the thin two-dot-dash line indicates an outer edge of an area (also referred to as a measurement area) Am1 subjected to measurement with the optical member. In FIG. 19, thin two-dot-dash arrows indicate a direction in which the liquid containing the multiple first particles P100 flows in the measurement fluidic channel 931m.

In this example, the concentration of the multiple first particles P100 in a sorted liquid obtained after the sample passes through the sorting fluidic channel 931s may be measured based on, for example, the intensity (also referred to as the reference light intensity) P0 of light passing through the measurement area Am1 when a liquid (also referred to as a reference liquid) containing none of the multiple types of particles is fed into the portion 9311u upstream of the main fluidic channel 9311 and the intensity (also referred to as the measurement light intensity) P1 of light passing through the measurement area Am1 when the liquid (sample) containing the multiple types of particles is fed into the portion 9311u upstream of the main fluidic channel 9311. For example, the concentration of the multiple first particles P100 in the sorted liquid may be calculated based on the optical loss (in dB) resulting from the presence of the multiple first particles P100 calculated using Formula 1 and the calibration curve indicating the relationship between the optical loss and the concentration of the multiple first particles P100.

$$Optical loss ( dB ) = - 10 \times {log}_{10} ( P 1 / P 0 ) \qquad ( 1 )$$

However, the first particles P100 flowing in the main fluidic channel 9311 of the sorting fluidic channel 931s while being pushed against the first side surface may also flow in the measurement fluidic channel 931m, as illustrated in FIG. 19, along a side surface located in one direction perpendicular to a direction from upstream to downstream of the measurement fluidic channel 931m. This reduces the percentage of the multiple first particles P100 in the measurement area Am1, and may reduce the difference between the reference light intensity P0 and the measurement light intensity P1. In this case, the optical loss (dB) calculated using, for example, Formula 1 may be smaller. In other words, the sensitivity to changes in the concentration of the multiple first particles P100 in the sorted liquid may be lower. This may lower the accuracy in optically measuring the multiple first particles P100 flowing through the fluidic channel in the fluidic device. In other words, this may lower the accuracy in optically measuring multiple particles of a specific type flowing through the fluidic channel in the fluidic device.

The fluidic device and the measurement apparatus including the fluidic device are to have improved accuracy in optically measuring the multiple particles flowing through the fluidic channel in the fluidic device.

The inventor of the present disclosure has developed a technique for improving the accuracy in optically measuring multiple particles flowing through a fluidic channel in a fluidic device.

Various embodiments and examples will now be described with reference to the drawings. In multiple drawings, the same reference numerals denote the same or similar components and functions. The components with the same or similar structures and functions will not be described repeatedly. The drawings are schematic.

Multiple drawings include the right-handed XYZ coordinate system for convenience. A positive Z-direction is hereafter defined as a vertically upward direction (or simply an upward direction). A vertically downward direction is also referred to as a negative Z-direction. The direction opposite to an X-direction is also referred to as a negative X-direction. The direction opposite to a Y-direction is also referred to as a negative Y-direction.

A “fluidic channel” described hereafter has a structure that allows a liquid to flow. The dimension of the fluidic channel in a direction perpendicular to a direction in which the fluidic channel extends along an XY plane is referred to as the width of the fluidic channel. The fluidic channel having a relatively small width indicates the fluidic channel is relatively narrow. The fluidic channel having a relatively large width indicates that the fluidic channel being relatively wide.

### 1. First Embodiment

### 1-1. Example Schematic Structure of Fluidic Device

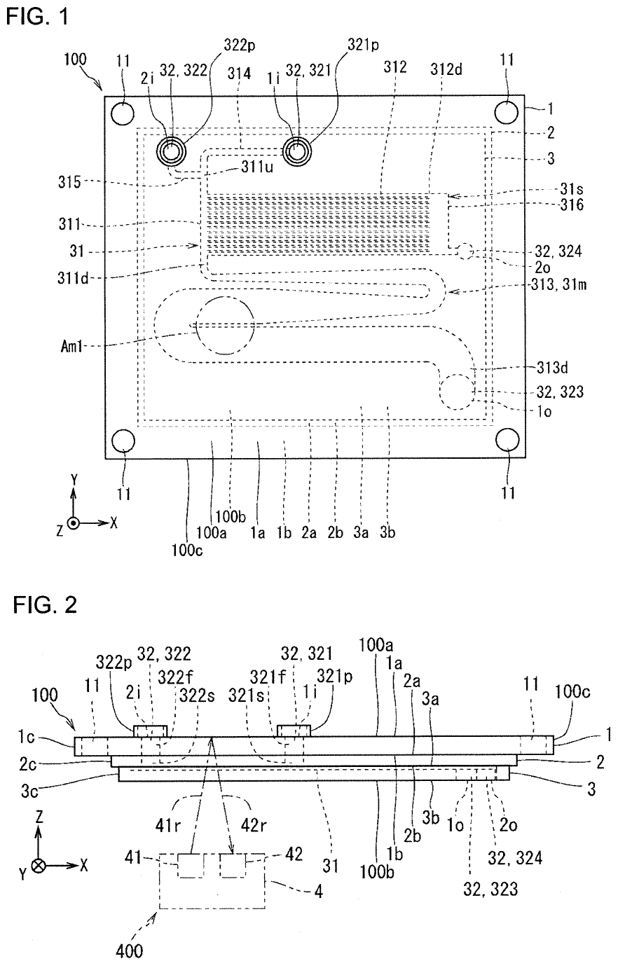

FIG. 1 is a schematic plan view of a fluidic device 100 according to a first embodiment, illustrating an example structure. FIG. 2 is a schematic front view of the fluidic device 100 according to the first embodiment, illustrating an example structure. In FIG. 2, an optical sensor 4 for measuring multiple particles flowing in the fluidic device 100 is drawn with thin two-dot-dash lines. An example path of light emitted from the optical sensor 4 and an example path of light reflected from the fluidic device 100 and entering the optical sensor 4 are indicated by dot-dash arrows.

In the first embodiment, the fluidic device 100 is, for example, a plate. The fluidic device 100 includes, for example, an upper surface 100a as a first surface and a lower surface 100b as a second surface opposite to the upper surface 100a. The fluidic device 100 includes, for example, a side surface 100c as a third surface connecting the upper surface 100a and the lower surface 100b. The upper surface 100a is located in the positive Z-direction from the lower surface 100b.

In the examples in FIGS. 1 and 2, the upper surface 100a faces in the positive Z-direction. In other words, the upper surface 100a is a surface along the XY plane and has a normal in the positive Z-direction. The lower surface 100b faces in the negative Z-direction. In other words, the lower surface 100b is a surface along the XY plane and has a normal in the negative Z-direction. The upper surface 100a is, for example, substantially flat and rectangular. The lower surface 100b is, for example, flat and rectangular. The side surface 100c is, for example, stepped.

The fluidic device 100 has a thickness of, for example, about several to ten millimeters (mm). The thickness of the fluidic device 100 refers to the dimension of the fluidic device 100 in the positive Z-direction. The upper surface 100a has a width of, for example, about 30 to 100 mm. The width of the upper surface 100a refers to the dimension of the upper surface 100a in the positive X-direction. The upper surface 100a has a length of, for example, about 40 to 120 mm. The length of the upper surface 100a refers to the dimension of the upper surface 100a in the positive Y-direction. The lower surface 100b has a width of, for example, about 20 to 90 mm. The width of the lower surface 100b refers to the dimension of the lower surface 100b in the positive X-direction. The lower surface 100b has a length of, for example, about 30 to 110 mm. The length of the lower surface 100b refers to the dimension of the lower surface 100b in the positive Y-direction.

The fluidic device 100 includes a fluidic channel section 31 and multiple holes 32. The fluidic channel section 31 is unopen in an outer surface of the fluidic device 100. The multiple holes 32 are each continuous with the fluidic channel section 31 and open in the outer surface of the fluidic device 100. “A first portion being continuous with a second portion” refers to the first portion being directly continuous with the second portion to allow a fluid such as a liquid to flow between the first portion and the second portion or refers to the first portion being continuous with the second portion through another portion (also referred to as a third portion) to allow a fluid to flow between the first portion and the second portion. The first portion, the second portion, and the third portion herein are each a portion in which a fluid can flow, such as a fluidic channel or a hole. The fluidic channel section 31 is inside the first fluidic device 100. In other words, the fluidic channel section 31 is, for example, unopen in any of the upper surface 100a, the lower surface 100b, or the side surface 100c. FIG. 2 illustrates the fluidic channel section 31 in a simplified manner.

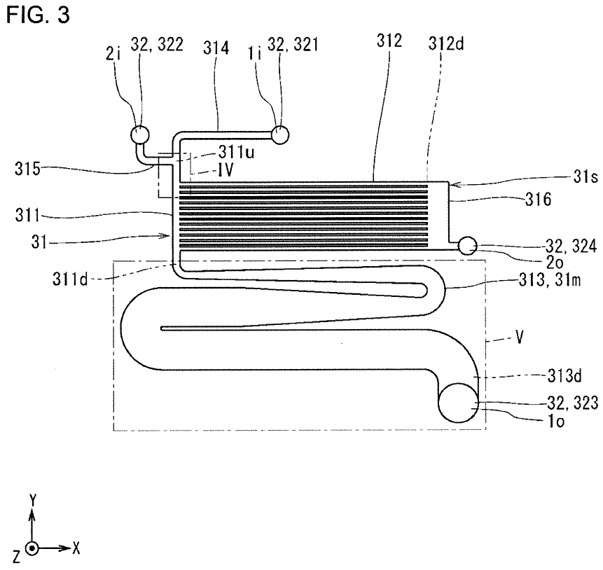

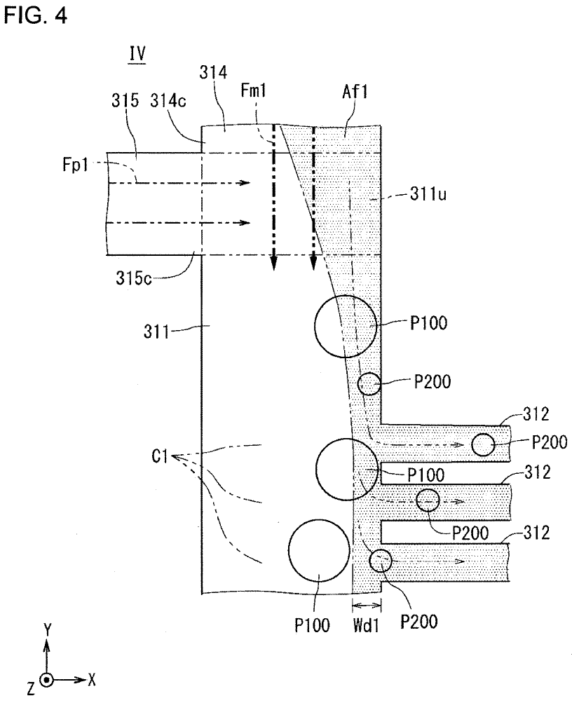

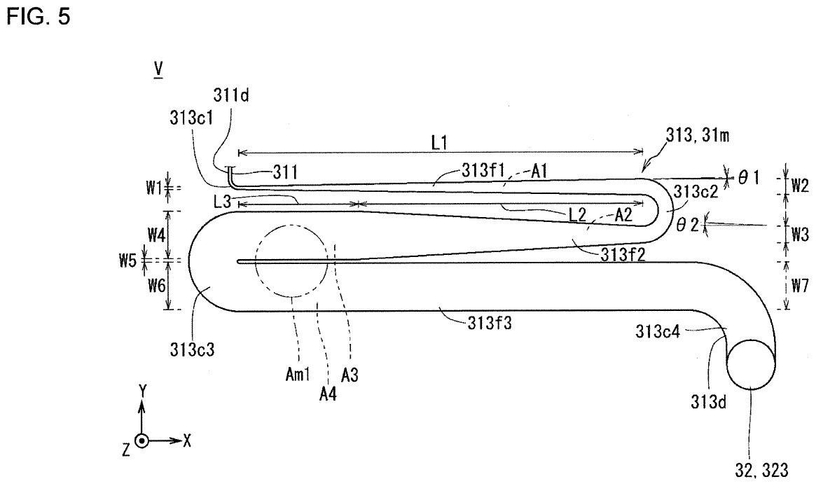

FIG. 3 is a schematic plan view of the fluidic channel section 31 and the multiple holes 32 in the fluidic device 100, illustrating example structures. In FIG. 3, the outer edge of the fluidic device 100 is not illustrated. The outer edges of the fluidic channel section 31, a first inlet hole 321, a second inlet hole 322, a first outlet hole 323, and a second outlet hole 324 are drawn with solid lines. FIG. 4 illustrates a part of the fluidic channel section 31. In FIG. 4, the outer edges of a main fluidic channel 311, multiple branch fluidic channels 312, a first introduction fluidic channel 314, and a second introduction fluidic channel 315 are drawn with solid lines. FIG. 5 illustrates a part of the fluidic channel section 31. In FIG. 5, the outer edges of the main fluidic channel 311, a measurement fluidic channel 313, and the first outlet hole 323 are drawn with solid lines.

### 1-1-1. Example Schematic Structure of Fluidic Channel Section

The fluidic channel section 31 includes multiple fluidic channels that are joined together and are unopen in the outer surface of the fluidic device 100. The multiple fluidic channels may each have, for example, a rectangular cross-section. In the embodiments of the present disclosure, the cross section of a fluidic channel may be an imaginary cross section of the fluidic channel along an imaginary plane perpendicular to a direction in which the fluidic channel extends.

As illustrated in FIGS. 1 to 3, the fluidic channel section 31 is located, for example, along the XY plane. The fluidic channel section 31 includes the main fluidic channel 311 as a first fluidic channel, the multiple branch fluidic channels 312 as multiple second fluidic channels, the measurement fluidic channel 313 as a third fluidic channel, the first introduction fluidic channel 314 as a fourth fluidic channel, and the second introduction fluidic channel 315 as a fifth fluidic channel.

The main fluidic channel 311 extends in the negative Y-direction as a first direction. The main fluidic channel 311 includes an upstream portion (also referred to as a first upstream portion) 311u and a downstream portion (also referred to as a first downstream portion) 311d. The first upstream portion 311u is located at an end of the main fluidic channel 311 in the positive Y-direction opposite to the negative Y-direction as the first direction. The first downstream portion 311d is located at an end of the main fluidic channel 311 in the negative Y-direction as the first direction. In other words, the main fluidic channel 311 extends in the negative Y-direction as the first direction from the first upstream portion 311u to the first downstream portion 311d. The main fluidic channel 311 may extend, for example, linearly in the negative Y-direction as the first direction. In other words, the main fluidic channel 311 may extend linearly in the negative Y-direction as the first direction from the first upstream portion 311u to the first downstream portion 311d.

The multiple branch fluidic channels 312 are each connected to the main fluidic channel 311 and are narrower than the main fluidic channel 311. The multiple branch fluidic channels 312 are each open in a side surface of the main fluidic channel 311 located in the positive X-direction as a second direction perpendicular to the negative Y-direction as the first direction between the first upstream portion 311u and the first downstream portion 311d. In other words, the main fluidic channel 311 includes a side surface (also referred to as a first side surface) located in the positive X-direction as the second direction. The multiple branch fluidic channels 312 are each open in the first side surface between the first upstream portion 311u and the first downstream portion 311d of the main fluidic channel 311. In still other words, the main fluidic channel 311 includes multiple portions (also referred to as connections) C1 connected to the respective multiple branch fluidic channels 312. For example, the multiple branch fluidic channels 312 branch from the main fluidic channel 311 at respective positions different from one another in the negative Y-direction as the first direction. In other words, the multiple connections C1 connected to the respective multiple branch fluidic channels 312 are at the respective positions different from one another in the negative Y-direction as the first direction. In the examples in FIGS. 1 and 3, the multiple branch fluidic channels 312 each extend in the positive X-direction as the second direction. In other words, the multiple branch fluidic channels 312 are arranged in the negative Y-direction as the first direction. The multiple branch fluidic channels 312 may be, for example, several tens to several hundreds of fluidic channels. In FIGS. 1 and 3, thirteen branch fluidic channels 312 are illustrated for convenience.

The first introduction fluidic channel 314 is connected to the first upstream portion 311u of the main fluidic channel 311. The first introduction fluidic channel 314 includes a portion (also referred to as a first connection) 314c connected to the first upstream portion 311u. The first connection 314c extends in the negative Y-direction as the first direction. In other words, the first introduction fluidic channel 314 extends in the negative Y-direction as the first direction to connect to the first upstream portion 311u of the main fluidic channel 311. The first introduction fluidic channel 314 is wider than each of the branch fluidic channels 312.

The second introduction fluidic channel 315 is connected to the first upstream portion 311u of the main fluidic channel 311. The second introduction fluidic channel 315 includes a portion (also referred to as a second connection) 315c connected to the first upstream portion 311u. The second connection 315c is open in a side surface of the first upstream portion 311u located in the negative X-direction as a third direction opposite to the second direction. In other words, the main fluidic channel 311 includes a side surface (also referred to as a second side surface) located in the negative X-direction as the third direction. The second connection 315c is open in the second side surface of the first upstream portion 311u. In still other words, the second introduction fluidic channel 315 extends in the positive X-direction as the second direction to connect to the first upstream portion 311u of the main fluidic channel 311. The second introduction fluidic channel 315 is wider than each of the branch fluidic channels 312.

The measurement fluidic channel 313 is connected to the first downstream portion 311d of the main fluidic channel 311. The measurement fluidic channel 313 includes a first channel portion 313f1, a second channel portion 313f2, a third channel portion 313f3, a first curved portion 313c1, a second curved portion 313c2, and a third curved portion 313c3.

The first channel portion 313f1 is a portion of the fluidic channel extending in the positive X-direction as the second direction. The second channel portion 313f2 is a portion of the fluidic channel extending in the negative X-direction as the third direction. The third channel portion 313f3 is a portion of the fluidic channel extending in the positive X-direction as the second direction. The second channel portion 313f2 is located opposite to the multiple branch fluidic channels 312 from the first channel portion 313f1. The third channel portion 313f3 is located opposite to the first channel portion 313f1 from the second channel portion 313f2. In other words, the first channel portion 313f1, the second channel portion 313f2, and the third channel portion 313f3 are arranged in this order in the negative Y-direction as the first direction. In still other words, the first channel portion 313f1 is located between the multiple branch fluidic channels 312 and the second channel portion 313f2 in the negative Y-direction as the first direction. The second channel portion 313f2 is located between the first channel portion 313f1 and the third channel portion 313f3.

The first curved portion 313cl is a portion of the fluidic channel connecting the first downstream portion 311d of the main fluidic channel 311 and an upstream portion of the first channel portion 313f1. The upstream portion of the first channel portion 313f1 is located at an end of the first channel portion 313f1 in the negative X-direction as the third direction. The first curved portion 313cl is an arc portion of the fluidic channel that is curved in the negative Y-direction as the first direction and then in the positive X-direction as the second direction. In other words, the first curved portion 313cl is curved from the first downstream portion 311d of the main fluidic channel 311 to the upstream portion of the first channel portion 313f1 continuously in the negative Y-direction as the first direction and then in the positive X-direction as the second direction.

The second curved portion 313C2 is a portion of the fluidic channel connecting a downstream portion of the first channel portion 313f1 and an upstream portion of the second channel portion 313f2. The downstream portion of the first channel portion 313f1 is located at an end of the first channel portion 313f1 in the positive X-direction as the second direction. The upstream portion of the second channel portion 313f2 is located at an end of the second channel portion 313f2 in the positive X-direction as the second direction. The second curved portion 313c2 is a semicircular arc portion of the fluidic channel that is curved in the positive X-direction as the second direction and then in the negative X-direction as the third direction. In other words, the second curved portion 313c2 is curved from the downstream portion of the first channel portion 313f1 to the upstream portion of the second channel portion 313f2 continuously in the positive X-direction as the second direction and then in the negative X-direction as the third direction.

The third curved portion 313c3 is a portion of the fluidic channel connecting a downstream portion of the second channel portion 313f2 and an upstream portion of the third channel portion 313f3. The downstream portion of the second channel portion 313f2 is located at an end of the second channel portion 313f2 in the negative X-direction as the third direction. The upstream portion of the third channel portion 313f3 is located at an end of the third channel portion 313f3 in the negative X-direction as the third direction. The third curved portion 313c3 is a semicircular arc portion of the fluidic channel that is curved in the negative X-direction as the third direction and then in the positive X-direction as the second direction. In other words, the third curved portion 313c3 is curved from the downstream portion of the second channel portion 313f2 to the upstream portion of the third channel portion 313f3 continuously in the negative X-direction as the third direction and then in the positive X-direction as the second direction.

In the examples in FIGS. 1 and 3, the measurement fluidic channel 313 is curved from a portion near the first downstream portion 311d sequentially in the negative Y-direction and then in the positive X-direction in the first curved portion 313c1, extends in the positive X-direction in the first channel portion 313f1, is curved in the positive X-direction and then in the negative X-direction in the second curved portion 313c2, extends in the positive X-direction in the second channel portion 313f2, is curved in the negative X-direction and then in the positive X-direction in the third curved portion 313c3, and extends in the positive X-direction in the third channel portion 313f3.

### 1-1-2. Example Schematic Structure of Multiple Holes

As illustrated in FIGS. 1 to 3, the multiple holes 32 include, for example, the first inlet hole 321, the second inlet hole 322, the first outlet hole 323, and the second outlet hole 324.

The first inlet hole 321 is connected to the first introduction fluidic channel 314. In other words, the first inlet hole 321 is connected to the first upstream portion 311u of the main fluidic channel 311 through the first introduction fluidic channel 314. In other words, the first inlet hole 321 is continuous with the first upstream portion 311u. The first inlet hole 321 has a diameter that is, for example, the same as or larger than the width of the first introduction fluidic channel 314. In the examples in FIGS. 1 and 3, the first introduction fluidic channel 314 is, for example, an L-shaped fluidic channel including a portion extending from the first inlet hole 321 in the negative X-direction as the third direction and a portion extending in the negative Y-direction as the first direction. These portions are connected in this order. In other words, the first introduction fluidic channel 314 extends from the first inlet hole 321 to the first upstream portion 311u in the negative X-direction and then in the negative Y-direction in this order.

The second inlet hole 322 is connected to the second fluidic channel 315. In other words, the second inlet hole 322 is connected to the first upstream portion 311u of the main fluidic channel 311 through the second introduction fluidic channel 315. In other words, the second inlet hole 322 is continuous with the first upstream portion 311u. The second inlet hole 322 has a diameter that is, for example, the same as or larger than the width of the second introduction fluidic channel 315. In the examples in FIGS. 1 and 3, the second introduction fluidic channel 315 is, for example, an L-shaped fluidic channel including a portion extending from the second inlet hole 322 in the negative Y-direction as the first direction and a portion extending in the positive X-direction as the second direction. These portions are connected in this order. In other words, the second introduction fluidic channel 315 extends from the second inlet hole 322 to the first upstream portion 311u in the negative Y-direction and in the positive X-direction in this order.

The first outlet hole 323 is continuous with a downstream portion (also referred to as a second downstream portion) 313d of the measurement fluidic channel 313. The second downstream portion 313d is a portion located at an end opposite to an upstream portion of the measurement fluidic channel 313 connected to the main fluidic channel 311. In other words, the first outlet hole 323 is connected to the first downstream portion 311d of the main fluidic channel 311 through the measurement fluidic channel 313. The first outlet hole 323 has a diameter that is, for example, the same as or larger than the width of the second downstream portion 313d. In the examples in FIGS. 1 and 3, the measurement fluidic channel 313 includes a fourth curved portion 313c4. The fourth curved portion 313c4 is a portion of the fluidic channel connecting a downstream portion of the third channel portion 313f3 and the first outlet hole 323. The downstream portion of the third channel portion 313f3 is a portion of the third channel portion 313f3 located at an end of the positive X-direction as the second direction. The fourth curved portion 313c4 is an arc portion of the fluidic channel that is curved in the positive X-direction as the second direction and then in the negative Y-direction as the first direction. In other words, the fourth curved portion 313c4 is curved from the downstream portion of the third channel portion 313f3 to the first outlet hole 323 continuously in the positive X-direction as the second direction and then in the negative Y-direction as the first direction. In this case, the downstream portion of the fourth curved portion 313c4 may be the second downstream portion 313d of the measurement fluidic channel 313. The downstream portion of the fourth curved portion 313c4 is a portion of the fourth curved portion 313c4 located at an end in the negative Y-direction as the first direction. The measurement fluidic channel 313 may include, for example, a portion connecting the fourth curved portion 313c4 and the first outlet hole 323. The portion connecting the fourth curved portion 313c4 and the first outlet hole 323 may be, for example, a portion extending in the negative Y-direction as the first direction.

The second outlet hole 324 is continuous with a portion (also referred to as a third downstream portion) 312d of each of the multiple branch fluidic channels 312 opposite to the main fluidic channel 311. For example, the second outlet hole 324 is connected to the downstream portion (third downstream portion) 312d of each of the multiple branch fluidic channels 312 through a first discharge fluidic channel 316 as a sixth fluidic channel. In other words, the fluidic channel section 31 includes the first discharge fluidic channel 316 as the sixth fluidic channel that connects the second outlet hole 324 and the third downstream portion 312d of each of the multiple branch fluidic channels 312. More specifically, for example, the multiple branch fluidic channels 312 are joined to the first discharge fluidic channel 316 at respective positions different from one another in the negative Y-direction as the first direction. For example, the first discharge fluidic channel 316 is wider than each of the branch fluidic channels 312 and has a volume sufficient for collecting influx of liquid through the multiple branch fluidic channels 312 and directing the collected liquid to the second outlet hole 324. In other words, for example, the first discharge fluidic channel 316 has a width (a dimension in the positive X-direction as the second direction) larger than the width of each of the branch fluidic channels 312. In this example, an edge of the first discharge fluidic channel 316 in the positive X-direction is located near the second outlet hole 324. For example, the second outlet hole 324 has a diameter that is the same as or larger than the width of the fluidic channel in a portion connected to the second outlet hole 324 at an end of the first discharge fluidic channel 316 in the negative Y-direction. In the examples in FIGS. 1 and 3, the first discharge fluidic channel 316 is an L-shaped fluidic channel including a portion that is wide in the positive X-direction and a portion that is narrow in the positive Y-direction connected in this order. The wide portion is connected to multiple third downstream portions 312d of the respective multiple branch fluidic channels 312 and extends linearly in the negative Y-direction as the first direction. The narrow portion extends linearly for a short distance in the positive X-direction as the second direction. In other words, the first discharge fluidic channel 316 extends in the negative Y-direction and then in the positive X-direction in a form of a collective outlet of the multiple branch fluidic channels 312 connected to the second outlet hole 324.

In the examples in FIGS. 1 to 3, the first inlet hole 321 and the second inlet hole 322 are each unopen in the lower surface 100b and open in the upper surface 100a. The first outlet hole 323 and the second outlet hole 324 are each not open in the upper surface 100a and open in the lower surface 100b. The first inlet hole 321 includes an opening (also referred to as a first inlet opening or a first inlet) 1i open in the upper surface 100a. The second inlet hole 322 includes an opening (also referred to as a second inlet opening or a second inlet) 2i open in the upper surface 100a. The first outlet hole 323 includes an opening (also referred to as a first outlet opening or a first outlet) 1o open in the lower surface 100b. The second outlet hole 324 includes an opening (also referred to as a second outlet opening or a second outlet) 20 open in the lower surface 100b.

### 1-1-3. Example Structure of Fluidic Device

As illustrated in FIGS. 1 and 2, the fluidic device 100 includes, for example, a first plate-like portion (also referred to as a first plate portion) 1, a second plate-like portion (also referred to as a second plate portion) 2, and a third plate-like portion (also referred to as a third plate portion) 3. The first plate portion 1 includes, for example, a first surface (also referred to as a first upper surface) 1a, a second surface (also referred to as a first lower surface) 1b opposite to the first upper surface 1a, and a third surface (also referred to as a first end face) 1c connecting the first upper surface 1a and the first lower surface 1b. The second plate portion 2 includes, for example, a first surface (also referred to as a second upper surface) 2a, a second surface (also referred to as a second lower surface) 2b opposite to the second upper surface 2a, and a third surface (also referred to as a second end face) 2c connecting the second upper surface 2a and the second lower surface 2b. The third plate portion 3 includes, for example, a first surface (also referred to as a third upper surface) 3a, a second surface (also referred to as a third lower surface) 3b opposite to the third upper surface 3a, and a third surface (also referred to as a third end face) 3c connecting the third upper surface 3a and the third lower surface 3b.

For example, the second upper surface 2a of the second plate portion 2 is bonded to the first lower surface 1b of the first plate portion 1. The third upper surface 3a of the third plate portion 3 is bonded to the second lower surface 2b of the second plate portion 2. The first lower surface 1b and the second upper surface 2a may be bonded together without an adhesive and may be bonded by, for example, surface modification of each of the first lower surface 1b of the first plate portion 1 and the second upper surface 2a of the second plate portion 2 and by contact between the first lower surface 1b and the second upper surface 2a. The second lower surface 2b and the third upper surface 3a may be bonded together without an adhesive and may be bonded by, for example, surface modification of each of the second lower surface 2b of the second plate portion 2 and the third upper surface 3a of the third plate portion 3 and by contact between the second lower surface 2b and the third upper surface 3a. The surface modification may be performed by, for example, irradiation of oxygen plasma or irradiation of ultraviolet (UV) light using an excimer lamp.

The first plate portion 1 has a thickness of, for example, about 1 to 5 mm. The thickness of the first plate portion 1 refers to the dimension of the first plate portion 1 in the positive Z-direction. The first plate portion 1 has a width of, for example, about 30 to 100 mm. The width of the first plate portion 1 refers to the dimension of the first plate portion 1 in the positive X-direction. The first plate portion 1 has a length of, for example, about 40 to 120 mm. The length of the first plate portion 1 refers to the dimension of the first plate portion 1 in the positive Y-direction.

The second plate portion 2 has a thickness of, for example, about 1 to 3 mm. The thickness of the second plate portion 2 refers to the dimension of the second plate portion 2 in the positive Z-direction. The second plate portion 2 has a width of, for example, about 20 to 90 mm. The width of the second plate portion 2 refers to the dimension of the second plate portion 2 in the positive X-direction. The second plate portion 2 has a length of, for example, about 30 to 110 mm. The length of the second plate portion 2 is the dimension of the second plate portion 2 in the positive Y-direction.

The third plate portion 3 has a thickness of, for example, about 1 to 3 mm. The thickness of the third plate portion 3 refers to the dimension of the third plate portion 3 in the positive Z-direction. The third plate portion 3 has a width of, for example, about 20 to 90 mm. The width of the third plate portion 3 refers to the dimension of the third plate portion 3 in the positive X-direction. The third plate portion 3 has a length of, for example, about 30 to 110 mm. The length of the third plate portion 3 refers to the dimension of the third plate portion 3 in the positive Y-direction.

In the examples in FIGS. 1 and 2, the side surface 100c includes the first end face 1c, a portion of the first lower surface 1b that is not bonded to the second upper surface 2a, the second end face 2c, a portion of the second lower surface 2b that is not bonded to the third upper surface 3a, and the third end face 3c. The outer surface of the fluidic device 100 includes the first upper surface 1a, the first end face 1c, the portion of the first lower surface 1b that is not bonded to the second upper surface 2a, the second end face 2c, the portion of the second lower surface 2b that is not bonded to the third upper surface 3a, the third end face 3c, and the third lower surface 3b.

The first plate portion 1 includes a through-hole (also referred to as a first through-hole) 321f being a part of the first inlet hole 321 and a through-hole (also referred to as a second through-hole) 322f being a part of the second inlet hole 322. The first plate portion 1 may include, for example, multiple through-holes 11 for alignment with the optical sensor 4. In the example in FIG. 1, the multiple through-holes 11 are four through-holes 11 defined near the respective four corners of the first plate portion 1.

The second plate portion 2 includes a through-hole (also referred to as a third through-hole) 321s being a part of the first inlet hole 321 and a through-hole (also referred to as a fourth through-hole) 322s being part of the second inlet hole 322. The first through-hole 321f and the third through-hole 321s form a single first inlet hole 321. The second through-hole 322f and the fourth through-hole 322s form a single second inlet hole 322.

The third plate portion 3 includes fine protrusions and recesses corresponding to a pattern of the fluidic channel section 31 on the third upper surface 3a, and includes the first outlet hole 323 and the second outlet hole 324. The second lower surface 2b and the third upper surface 3a are bonded together with the second lower surface 2b of the second plate portion 2 covering the third upper surface 3a of the third plate portion 3 with the fine protrusions and recesses corresponding to the pattern of the fluidic channel section 31. This structure forms the fluidic channel section 31.

The first plate portion 1 and the second plate portion 2 may be manufactured by resin molding or by, for example, punching two through-holes in a flat plate member manufactured by resin molding. The third plate portion 3 may be manufactured by, for example, resin molding.

The material for the first plate portion 1 may be, for example, a resin such as polycarbonate. The material for the second plate portion 2 may be, for example, a resin such as a silicone resin. The material for the third plate portion 3 may be, for example, a resin such as polydimethylsiloxane (PDMS). PDMS is highly transferrable in resin molding using molds. A transferrable material can produce a resin-molded product including fine protrusions and recesses corresponding to a fine pattern on the mold. For example, the second plate portion 2 made of a silicone resin is flexible, and the third plate portion 3 made of PDMS is also flexible. When the first plate portion 1 made of a highly rigid resin such as polycarbonate is used, for example, the second plate portion 2 and the third plate portion 3 bonded to the first plate portion 1 have lower flexibility. This structure is less likely to deteriorate the function of the fluidic device 100. For example, when the first plate portion 1 made of a highly rigid resin includes the first inlet opening 1i and the second inlet opening 2i, a liquid introduced into each of the first inlet opening 1i and the second inlet opening 2i with high pressure is less likely to deteriorate the function of the fluidic device 100. For example, when the first plate portion 1 is made of polycarbonate and the third plate portion 3 is made of PDMS, the second plate portion 2 made of a silicone resin located between the first plate portion 1 and the third plate portion 3 may indirectly bond polycarbonate and PDMS, which are not easily bonded together directly.

### 1-2. Overall Example Functions of Fluidic Device

The functions of the fluidic device 100 are roughly described below.

A liquid (also referred to as a first liquid or a sample) containing multiple first particles P100 and multiple second particles P200 as multiple types of particles (refer to FIG. 4) is introduced into the fluidic channel section 31 of the first fluidic device 100.

For example, the fluidic channel section 31 includes a portion (also referred to as the sorting fluidic channel) 31s for sorting and extracting the multiple first particles P100 of a specific type from the multiple second particles P200 of another type in the first liquid, and the measurement fluidic channel 313 as a portion 31m for measuring the multiple first particles P100 of a specific type extracted through the sorting fluidic channel 31s with the optical sensor 4. In the first embodiment, the sorting fluidic channel 31s includes, for example, the main fluidic channel 311, the multiple branch fluidic channels 312, the first introduction fluidic channel 314, and the second introduction fluidic channel 315. The first liquid may contain three or more types of multiple particles. In the example described below, the first particles P100 are of a single type, and the second particles P200 are of a single type.

### 1-2-1. Example Function of Sorting Fluidic Channel

A second liquid (also referred to as a pushing liquid) is introduced into the fluidic device 100 through the second inlet hole 322. The first liquid is introduced into the fluidic device 100 through the first inlet hole 321. Specific examples and the functions of the second liquid will be described later.

When the second liquid is introduced into the fluidic device 100 through the second inlet hole 322, a tube for feeding the second liquid, for example, may be connected to the fluidic device 100 from outside the fluidic device 100. To receive the tube, the upper surface 100a of the fluidic device 100, for example, may include a cylindrical portion 322p protruding in the positive Z-direction and surrounding the second inlet hole 322 about the Z-axis as viewed in plan. In the embodiments of the present disclosure, being as viewed in plan refers to being as viewed in plan in the negative Z-direction unless otherwise specified.

When the first liquid is introduced into the fluidic device 100 through the first inlet hole 321, a tube for feeding the first liquid, for example, may be connected to the fluidic device 100 from outside the fluidic device 100. To receive the tube, the upper surface 100a of the fluidic device 100, for example, may include a cylindrical portion 321p protruding in the positive Z-direction and surrounding the first inlet hole 321 about the Z-axis as viewed in plan.

For example, the first liquid introduced into the fluidic device 100 through the first inlet hole 321 flows into the first upstream portion 311u of the main fluidic channel 311 through the first introduction fluidic channel 314. In other words, the first inlet hole 321 serves as a hole for introducing the first liquid into the main fluidic channel 311.

For example, the second liquid introduced into the fluidic device 100 through the second inlet hole 322 flows into the first upstream portion 311u of the main fluidic channel 311 through the second introduction fluidic channel 315. In other words, the second inlet hole 322 serves as a hole for introducing the second liquid into the main fluidic channel 311.

In FIG. 4, two-dot-dash arrows Fp1 indicate a direction in which the second liquid flows. This direction is the positive X-direction as the second direction. In FIG. 4, two-dot-dash arrows Fm1 thicker than the arrows Fp1 indicate a direction in which the first liquid mainly flows (also referred to as a main flow) from the first introduction fluidic channel 314 into the main fluidic channel 311. The direction of the main flow is the negative Y-direction as the first direction. In FIG. 4, a rectangle drawn with a thin two-dot-dash line imaginarily indicates an outer edge of the first upstream portion 311u.

FIG. 4 schematically illustrates the first particles P100 with a larger diameter than the second particles P200 being sorted from the second particles P200. More specifically, for example, the branch fluidic channels 312 each have a width larger than the diameter of the second particles P200 and smaller than the diameter of the first particles P100. In this example, the width of the branch fluidic channels 312 refers to the dimension of the branch fluidic channels 312 in the negative Y-direction as the first direction. In other words, the first liquid contains multiple types of particles including the multiple first particles P100 each having a diameter larger than the width of the respective multiple branch fluidic channels 312 and the multiple second particles P200 each having a diameter smaller than the width of the respective multiple branch fluidic channels 312.

At least the main fluidic channel 311 and the first introduction fluidic channel 314 each have a width larger than the diameter of the first particles P100 and the diameter of the second particles P200. The width of the main fluidic channel 311 refers to the dimension of the main fluidic channel 311 in the positive X-direction as the second direction. The width of the first introduction fluidic channel 314 near the main fluidic channel 311 refers to the dimension of the first introduction fluidic channel 314 in the positive X-direction as the second direction. The width of the first introduction fluidic channel 314 at a position at which the first introduction fluidic channel 314 extends in the negative X-direction as the third direction refers to the dimension of the first introduction fluidic channel 314 in the negative Y-direction as the first direction.

The multiple second particles P200 move through the main fluidic channel 311 in the negative Y-direction as the first direction and receive a pushing force in the positive X-direction as the second direction. Most of the second particles P200 are thus introduced into any of the multiple branch fluidic channels 312. Most of the multiple second particles P200 contained in the first liquid flow through any of the multiple branch fluidic channels 312 and further through the first discharge fluidic channel 316, and are discharged out of the fluidic device 100 through the second outlet hole 324. In this example, the branch fluidic channels 312 connected to the main fluidic channel 311 each have a cross-sectional area and a length adjusted to cause the multiple second particles P200 to flow from the main fluidic channel 311 into any of the multiple branch fluidic channels 312 to be sorted from the multiple first particles P100. The second particles P200 discharged out of the fluidic device 100 through the second outlet hole 324 may undergo, for example, specific processing in another device connected to the second outlet hole 324 directly or through another member such as a tube, or may be simply collected. The multiple second particles P200 discharged out of the fluidic device 100 through the second outlet hole 324 may be discarded, for example, directly or through another member such as a tube.

The multiple first particles P100 move in the main fluidic channel 311 in the negative Y-direction as the first direction substantially without being introduced into the multiple branch fluidic channels 312. Most of the multiple first particles P100 flow into the measurement fluidic channel 313 through the main fluidic channel 311. The measurement fluidic channel 313 has a width larger than the first particles P100. The width of the measurement fluidic channel 313 refers to the dimension of the measurement fluidic channel 313 in a direction perpendicular to a direction from upstream to downstream in the measurement fluidic channel 313. The direction from upstream to downstream in the measurement fluidic channel 313 may be a direction in which the measurement fluidic channel 313 extends. In other words, the direction from upstream to downstream in the measurement fluidic channel 313 may be referred to as a longitudinal direction of the measurement fluidic channel 313.

In the first embodiment, a liquid is directed into each of the branch fluidic channels 312 using a flow (also referred to as a fluid-drawing flow). The fluid-drawing flow may facilitate sorting of the multiple first particles P100 from the multiple second particles P200 through the main fluidic channel 311 and the multiple branch fluidic channels 312. The fluid-drawing flow is indicated by a hatched area Af1 with a dot pattern in FIG. 4. The state of the fluid-drawing flow indicated by the area Af1 in FIG. 4 is a mere example and may vary based on the relationship between the flow velocity as well as the flow rate of the first liquid introduced into the main fluidic channel 311 through the first introduction fluidic channel 314 and the flow velocity as well as the flow rate of the second liquid introduced into the first upstream portion 311u of the main fluidic channel 311 through the second introduction fluidic channel 315. The area Af1 may be adjusted as appropriate to efficiently sort the multiple first particles P100 and the multiple second particles P200 from the first liquid. In the main fluidic channel 311, the second liquid in an area opposite to the multiple branch fluidic channels 312 directs the first liquid toward the multiple branch fluidic channels 312 in the positive X-direction as the second direction. In other words, the second liquid functions to push the first particles P100 and the second particles P200 as multiple types of particles against the side surface (first side surface) of the main fluidic channel 311 located in the positive X-direction as the second direction in the main fluidic channel 311. The second liquid may facilitate creation of the fluid-drawing flow.

In this example, the main fluidic channel 311 extends in the negative Y-direction as the first direction as described above. The first introduction fluidic channel 314 includes a portion connected to the first upstream portion 311u of the main fluidic channel 311 and extending in the negative Y-direction as the first direction. The multiple branch fluidic channels 312 are each open in the side surface (first side surface) located in the positive X-direction as the second direction between the first upstream portion 311u and the first downstream portion 311d of the main fluidic channel 311. The second introduction fluidic channel 315 is open in the side surface (second side surface) of the first upstream portion 311u of the main fluidic channel 311 located in the negative X-direction as the third direction.

With this structure, when the first liquid containing multiple types of particles is fed into the main fluidic channel 311 through the first inlet hole 321 with the second liquid being fed into the main fluidic channel 311 through the second inlet hole 322, a flow of liquid is created and directs the multiple types of particles toward the multiple branch fluidic channels 312 in the main fluidic channel 311. In other words, when the first liquid is introduced into the first upstream portion 311u through the first inlet hole 321 and the first introduction fluidic channel 314 with the second liquid being introduced into the first upstream portion 311u through the second inlet hole 322 and the second introduction fluidic channel 315, for example, the multiple first particles P100 and the multiple second particles P200 as the multiple types of particles contained in the first liquid can flow through the main fluidic channel 311 toward the first downstream portion 311d while being pushed against the multiple branch fluidic channels 312. Among the multiple first particles P100 and the multiple second particles P200 as the multiple types of particles, the second particles P200 with a diameter smaller than the width of each of the multiple branch fluidic channels 312 are thus more likely to flow into the multiple branch fluidic channels 312. Thus, among the multiple first particles P100 and the multiple second particles P200 as multiple types of particles in the first liquid, the multiple first particles P100 with a diameter larger than the width of each of the branch fluidic channels 312 and the multiple second particles P200 with a diameter smaller than the width of the branch fluidic channels 312 are sorted easily. In other words, a liquid (also referred to as a third liquid) containing, among the multiple first particles P100 and the multiple second particles as multiple types of particles, the multiple first particles P100 with a diameter larger than the width of each of the branch fluidic channels 312 may flow into the measurement fluidic channel 313.

In FIG. 4, the fluid-drawing flow in the main fluidic channel 311 has a width (also referred to as a first width) Wd1 near an area in which the main fluidic channel 311 branches into the multiple branch fluidic channels 312. In this example, the width of the fluid-drawing flow in the main fluidic channel 311 refers to the dimension of the fluid-drawing flow in the positive X-direction as the second direction. The first width Wd1 may be set by, for example, adjusting the cross-sectional area and the length of each of the main fluidic channel 311 and the multiple branch fluidic channels 312 as well as by adjusting the flow rates of the first liquid and the second liquid.

At the width Wd1 illustrated in FIG. 4, the area Af1 of the fluid-drawing flow does not include the center of gravity of each of the multiple first particles P100 and includes the center of gravity of each of the multiple second particles P200. In this example, the first width Wd1 is a width allowing the area Af1 of the fluid-drawing flow to include the center of gravity of the second particles P200. The second particles P200 thus effectively receive a force for causing the second particles P200 to flow into the branch fluidic channels 312 from the fluid-drawing flow. The second particles P200 can thus flow into the branch fluidic channels 312 wider than the diameter of the second particles P200. The first width Wd1, however, is a width not allowing the area Af1 of the fluid-drawing flow to include the center of gravity of the first particles P100. The first particles P100 do not receive a sufficient force for causing the first particles P100 to flow into the branch fluidic channels 312 from the fluid-drawing flow. The first particles P100 thus do not flow into the multiple branch fluidic channels 312 when, for example, the width of the branch fluidic channels 312 is slightly wider than the diameter of the first particles P100, and can flow through the main fluidic channel 311.

The first liquid is, for example, blood as a liquid containing multiple types of particles. In this case, for example, the first particles P100 are white blood cells, and the second particles P200 are red blood cells. In this case, the second liquid is, for example, phosphate buffered saline (PBS). The second liquid may be a liquid of PBS containing other elements to allow the second liquid to function appropriately for the purpose of using the fluidic device 100. The other elements may be, for example, ethylenediaminetetraacetic acid (EDTA) as a second element and bovine serum albumin (BSA) as a third element.

A red blood cell has the center of gravity at, for example, about 2 to 2.5 micrometers (μm) from its outer rim. A red blood cell has a maximum diameter of, for example, about 6 to 8 μm. A white blood cell has the center of gravity at, for example, about 5 to 10 μm from its outer rim. A white blood cell has a maximum diameter of, for example, about 10 to 20 μm. To effectively sort red blood cells and white blood cells in blood, the fluid-drawing flow has the first width Wd1 of about 2 to 10 μm.

The main fluidic channel 311 has an imaginary cross-sectional area of, for example, about 400 to 3000 square micrometers (μm²) along the XZ plane. The main fluidic channel 311 has a dimension (also referred to as a width) of, for example, about 20 to 40 μm in the positive X-direction as the second direction. The main fluidic channel 311 has a dimension (also referred to as a height) of, for example, about 20 to 100 μm in the positive Z-direction. The main fluidic channel 311 has a dimension of, for example, about 0.5 to 20 mm in the negative Y-direction as the first direction.

Each of the branch fluidic channels 312 has an imaginary cross-sectional area of, for example, about 100 to 500 μm² along the YZ plane. Each of the branch fluidic channels 312 has a dimension (also referred to as a width) of, for example, about 8 to 10 μm in the negative Y-direction as the first direction. Each of the branch fluidic channels 312 has a dimension (also referred to as a height) of, for example, about 20 to 80 μm in the positive Z-direction. Each of the branch fluidic channels 312 has a dimension of, for example, about 3 to 25 mm in the X direction.

A liquid in the main fluidic channel 311 flows at a flow rate per unit time of, for example, about 10 to 100 microliters per second (μl/s). The first liquid introduced into the main fluidic channel 311 through the first inlet hole 321 and the first introduction fluidic channel 314 flows at a flow rate per unit time of, for example, about 3 to 30 μl/s. The second liquid introduced into the main fluidic channel 311 through the second inlet hole 322 and the second introduction fluidic channel 315 flows at a flow rate per unit time of, for example, about 7 to 70 μl/s.

### 1-2-2. Example Functions of Measurement Fluidic Channel

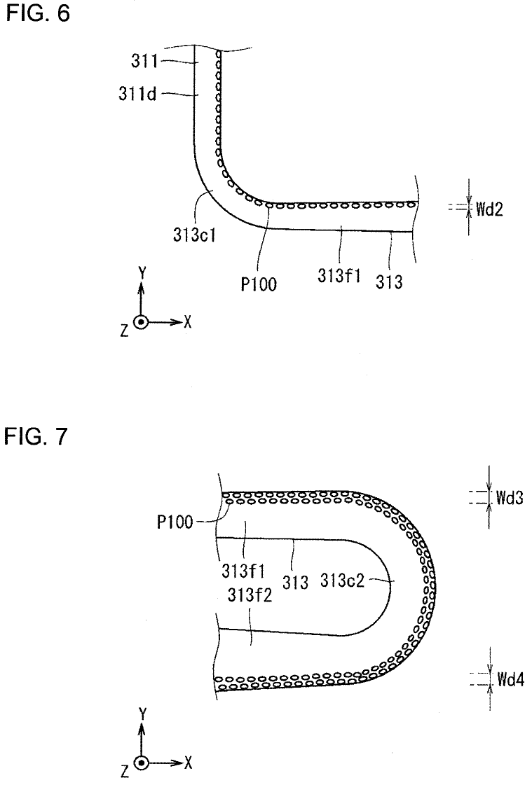

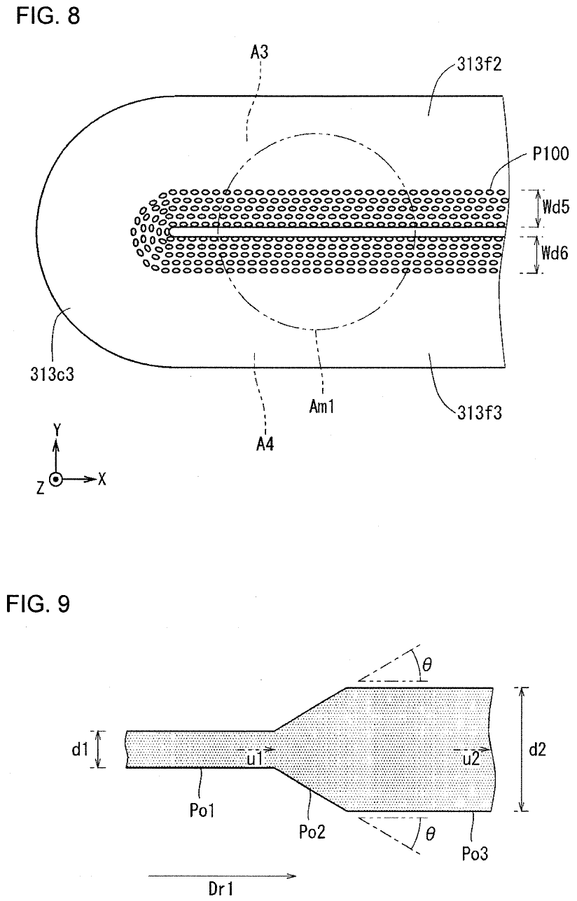

FIG. 6 is a schematic plan view of an example of the multiple first particles P100 flowing in an area of the fluidic channel section 31 extending from the first downstream portion 311d of the main fluidic channel 311 to the upstream portion of the first channel portion 313f1 of the measurement fluidic channel 313. FIG. 7 is a schematic plan view of an example of the multiple first particles P100 flowing in an area of the measurement fluidic channel 313 extending from the downstream portion of the first channel portion 313f1 to the upstream portion of the second channel portion 313f2. FIG. 8 is a schematic plan view of an example of the multiple first particles P100 flowing in an area of the measurement fluidic channel 313 extending from a third area A3 in the second channel portion 313f2 to a fourth area A4 in the third channel portion 313f3.

As described above, in the main fluidic channel 311 of the sorting fluidic channel 31s, the multiple first particles P100 flow while being pushed against the side surface (first side surface) of the main fluidic channel 311 located in the positive X-direction as the second direction. In the first curved portion 313cl and in the upstream portion of the first channel portion 313f1, the multiple first particles P100, remaining under the influence of the fluid-drawing flow in the main fluidic channel 311, also flow along a side surface located in one direction perpendicular to the longitudinal direction of the measurement fluidic channel 313 as illustrated in FIG. 6, for example. In other words, the multiple first particles P100 may flow in a row along the side surface located in one direction perpendicular to the longitudinal direction of the measurement fluidic channel 313 also in the first curved portion 313cl and in the upstream portion of the first channel portion 313f1.

In the example in FIG. 6, the multiple first particles P100 may flow in the first channel portion 313f1 while being pushed against a side surface (also referred to as a third side surface) of the first channel portion 313f1 located in the positive Y-direction as a fourth direction opposite to the first direction. The third side surface is a side surface of the first channel portion 313f1 located in the positive Y-direction as the fourth direction. In other words, the first channel portion 313f1 includes the side surface (third side surface) located in the positive Y-direction as the fourth direction. In other words, in the first channel portion 313f1, the multiple first particles P100 may flow in a row along the side surface (third side surface) of the first channel portion 313f1 located in the positive Y-direction as the fourth direction opposite to the first direction.

The measurement fluidic channel 313 has a dimension (also referred to as a height) of, for example, about 20 to 100 μm in the positive Z-direction. In the first embodiment, the height of the measurement fluidic channel 313 is, for example, substantially uniform in the longitudinal direction.

In the first embodiment, the first channel portion 313f1 includes an area (also referred to as a first area) A1 that is wider at positions farther in the positive X-direction as the second direction as illustrated in FIG. 5. The width of the first channel portion 313f1 may refer to, for example, the dimension of the first channel portion 313f1 in the negative Y-direction as the first direction. The upstream portion of the first channel portion 313f1 may have a width W1 that is, for example, substantially the same as the width of the main fluidic channel 311. The downstream portion of the first channel portion 313f1 has a width W2 larger than the width W1 of the upstream portion of the first channel portion 313f1. In the first area A1, the width of the first channel portion 313f1 increases continuously at positions farther in the positive X-direction as the second direction. When the percentage of the first area A1 in the first channel portion 313f1 in the positive X-direction as the second direction is large, the width of the first channel portion 313f1 may increase gradually at positions farther in the positive X-direction as the second direction. The percentage of the first area A1 in the first channel portion 313f1 in the positive X-direction as the second direction may be in the range of, for example, 50 to 100 percent (%), 70 to 100%, or 90 to 100%.

For the first channel portion 313f1, the width W1 may be, for example, about 20 to 40 μm. The width W2 may be, for example, about 400 to 600 μm, or about 500 μm. The width W2 may be, for example, about 12.5 times the width W1, or may be greater than or equal to about 12.5 times the width W1. In other words, when an expansion rate (also referred to as a first expansion rate) m1 of the first channel portion 313f1 is defined as a value obtained by dividing the width W2 of the downstream portion of the first channel portion 313f1 by the width W1 of the upstream portion of the first channel portion 313f1, or W2/W1, the first expansion rate m1 may be set to 12.5 or greater. The first expansion rate m1 may be referred to as, for example, the rate with which the first channel portion 313f1 is wider or as the rate with which the width W2 of the downstream portion increases from the width W1 of the upstream portion in the first channel portion 313f1. The first channel portion 313f1 may have a length L1 of, for example, about 10 to 20 mm or about 12 to 13 mm in the positive X-direction as the second direction. The first area A1 may have a length of, for example, about 9 to 20 mm, or about 12 to 13 mm in the positive X-direction as the second direction. The first channel portion 313f1 in the first area A1 may have an expansion angle (also referred to as a first expansion angle) 01 of, for example, about 0.02 to 0.03 radians (rad). The first expansion angle θ1 may be, for example, an angle formed by an imaginary line parallel to the center line of the first area A1 and a side surface of the first area A1 as viewed in plan. The center line of the first area A1 may be an imaginary line passing through the center of the cross section perpendicular to the longitudinal direction of the measurement fluidic channel 313 in the first area A1. The center line of the first area A1 may extend, for example, in the positive X-direction as the second direction.

The second channel portion 313f2 has an area (also referred to as a second area) A2 that is wider at positions farther in the negative X-direction as the third direction. The width of the second channel portion 313f2 may refer to, for example, the dimension of the second channel portion 313f2 in the negative Y-direction as the first direction. The upstream portion of the second channel portion 313f2 may have a width W3 that is, for example, substantially the same as the width W2 of the downstream portion of the first channel portion 313f1. The downstream portion of the second channel portion 313f2 has a width W4 that is larger than the width W3 of the upstream portion of the second channel portion 313f2. In the second area A2, the width of the second channel portion 313f2 increases continuously at positions farther in the negative X-direction as the third direction. When the percentage of the second area A2 in the second channel portion 313f2 in the negative X-direction as the third direction is large, the width of the second channel portion 313f2 may increase gradually at positions farther in the negative X-direction as the third direction. The percentage of the second area A2 in the second channel portion 313f2 in the negative X-direction as the third direction may be in the range of, for example, 50 to 90%, 60 to 90%, or 70 to 90%.

For the second channel portion 313f2, the width W3 may be, for example, about 400 to 600 μm or about 500 μm. The width W4 may be, for example, about 1200 to 1800 μm or about 1500 μm. The width W4 may be, for example, about three times the width W3. In other words, when an expansion rate (also referred to as a second expansion rate) m2 of the second channel portion 313f2 is defined as a value obtained by dividing the width W4 of the downstream portion of the second channel portion 313f2 by the width W3 of the upstream portion of the second channel portion 313f2, or W4/W3, the second expansion rate m2 may be about 3. The second expansion rate m2 may be referred to as, for example, the rate with which the second channel portion 313f2 is wider or as the rate with which the width W4 of the downstream portion increases from the width W3 of the upstream portion in the second channel portion 313f2. The second area A2 may have a length L2 of, for example, about 7 to 17 mm or about 10 mm in the negative X-direction as the third direction. The second channel portion 313f2 in the second area A2 may have an expansion angle (second expansion angle) 02 of, for example, about 0.019 to 0.05 rad. The second expansion angle θ2 is, for example, an angle formed by an imaginary line parallel to the center line of the second area A2 and a side surface of the second area A2 as viewed in plan. The center line of the second area A2 may be an imaginary line passing through the center of the cross section of the second area A2 perpendicular to the longitudinal direction of the measurement fluidic channel 313 in the first area A1. The center line of the second area A2 may extend, for example, in the negative X-direction as the third direction.

The second channel portion 313f2 also includes an area (also referred to as a third area) A3 between the second area A2 and the third curved portion 313c3. In the third area A3, the second channel portion 313f2 may have, for example, a substantially uniform width W4. The percentage of the third area A3 in the second channel portion 313f2 in the negative X-direction as the third direction at a percentage may be in the range of, for example, 10 to 30%. For example, when the percentage of the third area A3 in the second channel portion 313f2 in the negative X-direction as the third direction is small, the second channel portion 313f2 is less likely to be larger. This may reduce the size of the fluidic device 100. The third area A3 may have a length L3 of, for example, about 2 to 4 mm or about 3 mm in the negative X-direction as the third direction.

The third channel portion 313f3 includes an area (also referred to as a fourth area) A4 located along the third area A3. The third area A3 in the second channel portion 313f2 and the fourth area A4 in the third channel portion 313f3 may be, for example, adjacent to and substantially parallel to each other. The third area A3 and the fourth area A4 extend in a parallel direction or substantially parallel directions as viewed in plan. For example, a side surface of the fourth area A4 adjacent to the third area A3 may be parallel to or inclined with respect to a side surface of the third area A3 adjacent to the fourth area A4 as viewed in plan. Inclined side surfaces may form an angle within the range of a first predetermined angle to a second predetermined angle greater than the first predetermined angle. The first predetermined angle may be an angle greater than 0 degrees. The second predetermined angle may be any angle between, for example, 1 to 3 degrees, 3 to 5 degrees, or 5 to 10 degrees.

A distance W5 between the third area A3 in the second channel portion 313f2 and the fourth area A4 in the third channel portion 313f3 may be, for example, smaller than or equal to one tenth the width of each of the third area A3 and the fourth area A4, or smaller than or equal to 100 μm. The distance W5 may be as small as possible to allow stable fabrication of the portion between the third area A3 and the fourth area A4. The third channel portion 313f3 may have, for example, a substantially uniform width of a width W6 in the fourth area A4, or may have a substantially uniform width throughout the upstream portion of the third channel portion 313f3 to the downstream portion of the third channel portion 313f3. The width of the third channel portion 313f3 may refer to, for example, the dimension of the third channel portion 313f3 in the positive Y-direction as the fourth direction. The width W6 of the upstream portion of the third channel portion 313f3 may be, for example, substantially the same as the width W4 of the downstream portion of the second channel portion 313f2. The width W6 of the upstream portion of the third channel portion 313f3 may be, for example, substantially the same as a width W7 of the downstream portion of the third channel portion 313f3.

For the third channel portion 313f3, the fourth area A4 may have a length of, for example, about 2 to 4 mm or about 3 mm in the positive X-direction as the second direction. The width W6 and the width W7 may each be, for example, about 1200 to 1800 μm or about 1500 μm.

In the measurement fluidic channel 313 in the first embodiment, the first channel portion 313f1 and the second channel portion 313f2 are each wider toward the downstream portion. The width of the measurement fluidic channel 313 can thus increase gradually. This may reduce disturbance in the flow of the third liquid in the measurement fluidic channel 313.

In the first area A1 of the first channel portion 313f1, an area defined by the multiple first particles P100 flowing along the side surface (third side surface) of the first channel portion 313f1 located in the positive Y-direction as the fourth direction may be gradually wider as the width of the first channel portion 313f1 increases gradually toward the second curved portion 313c2. In this case, the flow velocity of the third liquid flowing through the first channel portion 313f1 may also decrease gradually as the width of the first channel portion 313f1 increases gradually. This gradual decrease in the flow velocity of the third liquid may occur based on the law of conservation of mass defining that the mass of fluid flowing per unit time remains constant independent of changes in the cross-sectional area of a fluidic channel as the width of the first channel portion 313f1 increases gradually. The width of an area defined by the multiple first particles P100 flowing along the side surface (third side surface) of the first channel portion 313f1 located in the positive Y-direction as the fourth direction may refer to, for example, the dimension of the area, which is defined by the multiple first particles P100 flowing along the side surface (third side surface) of the first channel portion 313f1 located in the positive Y-direction as the fourth direction, in the positive Y-direction as the fourth direction.

In the examples in FIGS. 6 and 7, the width of the area including the multiple first particles P100 flowing along the side surface (third side surface) of the first channel portion 313f1 located in the positive Y-direction as the fourth direction is about a second width Wd2 in the upstream portion of the first channel portion 313f1 and about a third width Wd3 in the downstream portion of the first channel portion 313f1. The third width Wd3 is larger than the second width Wd2.

In the second area A2 of the second channel portion 313f2, an area defined by the multiple first particles P100 flowing along a side surface (also referred to as a fourth side surface) of the second channel portion 313f2 located in the negative Y-direction as the first direction may be gradually wider toward the third area A3 as the width of the second channel portion 313f2 increases gradually. The fourth side surface is a side surface of the second channel portion 313f2 located in the negative Y-direction as the first direction. In other words, the second channel portion 313f2 includes the side surface (fourth side surface) located in the negative Y-direction as the first direction. In this case, the flow velocity of the third liquid flowing through the second channel portion 313f2 may also decrease gradually as the width of the second channel portion 313f2 increases gradually. This gradual decrease in the flow velocity of the third liquid may occur based on the law of conservation of mass defining that the mass of fluid flowing per unit time remains constant independently of changes in the cross-sectional area of a fluidic channel as the width of the second channel portion 313f2 increases gradually. The width of an area including multiple first particles P100 flowing along the side surface (fourth side surface) of the second channel portion 313f2 located in the negative Y-direction as the first direction may refer to, for example, the dimension of the area defined by the multiple first particles P100 flowing along the side surface (fourth side surface) of the second channel portion 313f2 located in the negative Y-direction as the first direction. The dimension of the area refers to a dimension in the negative Y-direction as the first direction.

In the examples in FIGS. 7 and 8, the width of the area defined by the multiple first particles P100 flowing along the side surface (fourth side surface) of the second channel portion 313f2 located in the negative Y-direction as the first direction is about a fourth width Wd4 in the upstream portion of the second channel portion 313f2 and about a fifth width Wd5 in the downstream portion of the second channel portion 313f2. The fifth width Wd5 is larger than the fourth width Wd4. The fourth width Wd4 may be, for example, substantially the same as the third width Wd3. In the example in FIG. 8, the area defined by the multiple first particles P100 flowing along the side surface (fourth side surface) of the second channel portion 313f2 located in the negative Y-direction as the first direction has a substantially uniform width of about the fifth width Wd5 in the third area A3. The fifth width Wd5 may be, for example, about 500 μm.

In the third channel portion 313f3, an area defined by the multiple first particles P100 flowing along a side surface (also referred to as a fifth side surface) located in the positive Y-direction as the fourth direction and extending along the second channel portion 313f2 may have a width that is substantially the same as or larger than the increased width of the area defined by the multiple first particles P100 flowing in the second channel portion 313f2. The width of an area defined by the multiple first particles P100 flowing along the side surface (fifth side surface) of the third channel portion 313f3 located in the positive Y-direction as the fourth direction may refer to, for example, the dimension of the area defined by the multiple first particles P100 flowing along the side surface (fifth side surface) of the third channel portion 313f3 located in the positive Y-direction as the fourth direction. The dimension of the area refers to a dimension in the positive Y-direction as the fourth direction. The fifth side surface is a side surface of the third channel portion 313f3 located in the positive Y-direction as the fourth direction. In other words, the third channel portion 313f3 includes the side surface (fifth side surface) located in the positive Y-direction as the fourth direction.

In the example in FIG. 8, the width of the area defined by the multiple first particles P100 flowing in the fourth area A4 is about a sixth width Wd6. The sixth width Wd6 may be, for example, substantially the same as the fifth width Wd5. The sixth width Wd6 may be, for example, about 500 μm.

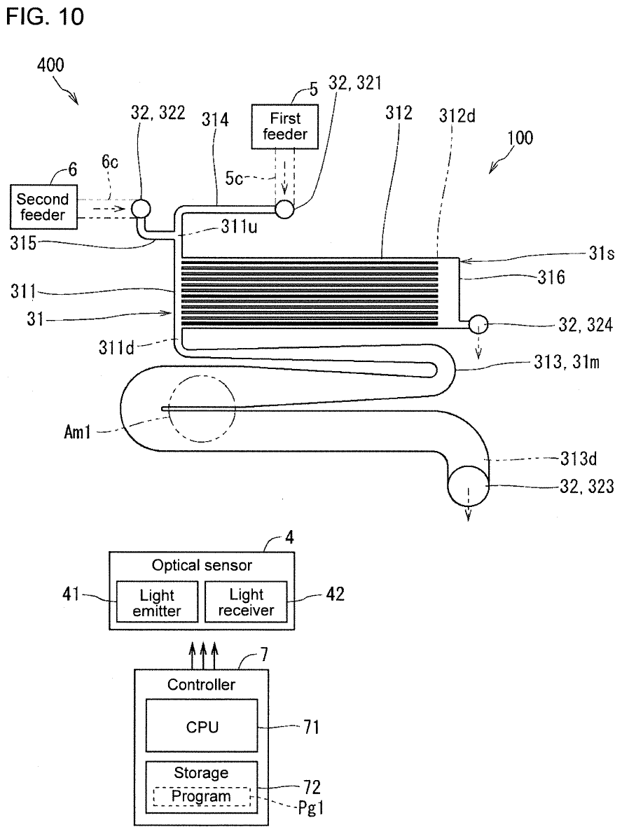

As illustrated in FIGS. 5 and 8, an area (also referred to as a measurement area) Am1 for the optical sensor 4 to measure the multiple first particles P100 (refer to FIGS. 2 and 10) may be defined to overlap an area extending from the third area A3 to the fourth area A4 as viewed in plan. In this case, the measurement area Am1 may include the multiple first particles P100 in the third area A3 flowing along the side surface (fourth side surface) adjacent to the fourth area A4 while spreading about the fifth width Wd5 wide, and the multiple first particles P100 in the fourth area A4 flowing along the side surface (fifth side surface) adjacent to the third area A3 while spreading about the sixth width Wd6 wide.

As illustrated in FIG. 8, the percentage of the area defined by the flowing multiple first particles P100 in the measurement area Am1 as viewed in plan for the measurement fluidic channel 313 is thus greater than the percentage of the area defined by the flowing multiple first particles P100 in the measurement area Am1 for the bending measurement fluidic channel 931m illustrated in FIG. 19. The number of multiple first particles P100 in the area overlapping the measurement area Am1 as viewed in plan may thus change more greatly in the measurement fluidic channel 313 than in the measurement fluidic channel 931m as the concentration of the multiple first particles P100 in the third liquid changes. In other words, the optical sensor 4 may have a higher sensitivity in measuring the concentration of the multiple first particles P100. This can improve the accuracy in optically measuring the multiple first particles P100 flowing through the measurement fluidic channel 313 in the fluidic device 100. For example, this can improve the accuracy in optically measuring the concentration of the multiple first particles P100 flowing through the measurement fluidic channel 313 in the fluidic device 100.

Additionally, in the first embodiment, when misalignment occurs between the measurement fluidic channel 313 and the measurement area Am1, the percentage of the area defined by the flowing multiple first particles P100 in the measurement area Am1 decreases by a smaller rate. This can improve the accuracy in optically measuring the multiple first particles P100 flowing through the measurement fluidic channel 313 in the fluidic device 100. For example, this can improve the accuracy in optically measuring the concentration of the multiple first particles P100 flowing through the measurement fluidic channel 313 in the fluidic device 100. Note that misalignment between the measurement fluidic channel 313 and the measurement area Am1 may be caused by, for example, an error in the position of the fluidic channel section 31 in the fluidic device 100 during the manufacture of the fluidic device 100 and by an error in the positional relationship during the alignment of the fluidic device 100 and the optical sensor 4. An error in the position of the fluidic channel section 31 in the fluidic device 100 during the manufacture of the fluidic device 100 may be caused, for example, when the third plate portion 3 is bonded to the first plate portion 1 with the second plate portion 2 between the third plate portion 3 and the first plate portion 1. An error in the positional relationship during the alignment of the fluidic device 100 and the optical sensor 4 may be caused by, for example, errors in the positions of the multiple through-holes 11 in the first plate portion 1.

The measurement area Am1 may be circular or oval as viewed in plan. The measurement area Am1 may have a diameter of, for example, about 1500 to 2500 μm or about 2000 μm. For example, in the measurement area Am1, the percentage of an area overlapping the third area A3 may be in the range of 80 to 120% or 90 to 110% of the percentage of an area overlapping the fourth area A4 as viewed in plan. For example, in the measurement area Am1, the percentage of the area overlapping the third area A3 and the percentage of the area overlapping the fourth area A4 may be substantially the same as viewed in plan. In the examples in FIGS. 5 and 8, the center of the measurement area Am1 is located in an area between the third area A3 and the fourth area A4 as viewed in plan.

FIG. 9 is a conceptual diagram describing the loss of liquid pressure resulting from an increased cross-sectional area of a fluidic channel. In FIG. 9, a fluid flows in an area hatched in a stipple pattern. As illustrated in FIG. 9, a first tubular portion Po1, a second tubular portion Po2, and a third tubular portion Po3 are connected in this order in a direction Dr1 indicated by a thin arrow. The first tubular portion Po1 is a circular tubular portion with a uniform inner diameter of a first inner diameter d1. The second tubular portion Po2 is a tubular portion with an inner surface extending along the side surface of a conical frustum that has an inner diameter increasing from the first inner diameter d1 to a second inner diameter d2 at positions farther in the direction Dr1. The third tubular portion Po3 is a circular tubular portion with a uniform inner diameter of the second inner diameter d2. The fluid flowing in the first tubular portion Po1 in the direction Dr1 flows at a speed (also referred to as a flow velocity) of a first flow velocity u1. The fluid flowing in the third tubular portion Po3 in the direction Dr1 flows at a speed (flow velocity) of a second flow velocity u2. The inner surface of the second tubular portion Po2 has an expansion angle of an angle θ. The expansion angle corresponds to an angle between an imaginary line in the direction Dr1 and the inner surface of the second tubular portion Po2. Formula 2 applies for the shape-related head loss h_{ge} as the loss of energy resulting from an increased cross-sectional area of a fluidic channel, where the shape-related head loss is h_{ge} (in unit of meter, or m), the loss coefficient for gradual expansion is f_{ge}, and the acceleration of gravity is g (meters per second squared, or m/s²).

h_{ge}=f_{ge}×[1−(d1/d2)²]²×(u1^{2/2}g) (2)

When the angle θ is small, the gradual expansion loss coefficient f_{ge} obtainable through experiments is about 0.2. Formula 2 shows that a higher first flow velocity u1 may generate a vortex in the fluid in the second tubular portion Po2 and the third tubular portion Po3. When the flow velocity of the fluid in a portion including the curved fluidic channel is the first flow velocity u1, a vortex may be generated in the fluid in proportion to the square of the first flow velocity u1. In the measurement fluidic channel 313, when the first expansion rate m1 is greater than the second expansion rate m2, for example, the flow velocity of the third liquid may decrease in the first channel portion 313f1. The flow velocity of the third liquid may thus decrease in the second curved portion 313c2. This may reduce disturbance in the flow of the third liquid in the second curved portion 313c2. In other words, the flow of the multiple first particles P100 is less likely to be disturbed. The multiple first particles P100 are thus less likely to be dense or sparse in the measurement area Am1. This can improve the accuracy in optically measuring the multiple first particles P100 flowing through the measurement fluidic channel 313 in the fluidic device 100.

When the first expansion rate m1 is less than or equal to about five times the second expansion rate m2, for example, the first channel portion 313f1, the second curved portion 313c2, and the second channel portion 313f2 are less likely to be larger. The fluidic device 100 may thus be less likely to be larger. In other words, the fluidic device 100 may be smaller. For example, the first expansion rate m1 may be about 12.5, and the second expansion rate m2 may be about 3. In this case, the flow velocity of the third liquid may be reduced by a factor of about 12.5 in the first channel portion 313f1, and by a factor of about 3 in the second channel portion 313f2 based on, for example, the law of conservation of mass.

Additionally, when the first expansion rate m1 is less than or equal to about five times the second expansion rate m2, for example, a portion in which the third liquid flows slowly is smaller in the measurement fluidic channel 313. This can reduce the time for collecting the third liquid discharged through the first outlet hole 323 after passing through the measurement fluidic channel 313.

In this example, for the first expansion angle θ1 in the first area A1, a larger first expansion angle θ1 provides a shorter first channel portion 313f1 and effectively reduces the size of the fluidic device 100. A smaller first expansion angle θ1 effectively reduces disturbance in the flow of the third liquid and the multiple first particles P100 in the first channel portion 313f1. The first expansion angle θ1 may thus be set as appropriate to achieve an appropriate balance between reducing the size of the fluidic device 100 and reducing disturbance in the flow of the third liquid and the multiple first particles P100 in the first channel portion 313f1. For example, the first expansion angle θ1 in the first area A1 may be about 0.02 to 0.03 rad.

In this example, for the second expansion angle θ2 in the second area A2, a larger second expansion angle θ2 provides a shorter second channel portion 313f2 and effectively reduce the size of the fluidic device 100. A smaller second expansion angle θ2 effectively reduces disturbance in the flow of the third liquid and the multiple first particles P100 in the second channel portion 313f2. The second expansion angle θ2 may thus be set as appropriate to achieve an appropriate balance between reducing the size of the fluidic device 100 and reducing disturbance in the flow of the third liquid and the multiple first particles P100 in the second channel portion 313f2. For example, the second expansion angle θ2 in the second area A2 may be about 0.019 to 0.05 rad.

The second curved portion 313c2 may have, for example, a uniform width. The width of the second curved portion 313c2 may refer to, for example, the dimension of the second curved portion 313c2 in a direction perpendicular to the longitudinal direction of the measurement fluidic channel 313 in the second curved portion 313c2 as viewed in plan. In this case, the width W2 of the downstream portion of the first channel portion 313f1 may be substantially the same as the width W3 of the upstream portion of the second channel portion 313f2. The width of the second curved portion 313c3 may be, for example, about 400 to 600 μm or about 500 μm as the width W2 and the width W3. The second curved portion 313c3 may have a curvature radius of, for example, about 400 to 1200 μm as viewed in plan.

This structure may reduce disturbance in the third liquid in the second curved portion 313c2. In other words, the flow of the multiple first particles P100 in the second curved portion 313c2 is less likely to be disturbed. The multiple first particles P100 are thus less likely to be dense or sparse in the measurement area Am1. This can improve the accuracy in optically measuring the multiple first particles P100 flowing through the measurement fluidic channel 313 in the fluidic device 100. This may also reduce the likelihood of a larger fluidic channel section 31 resulting from a larger second curved portion 313c2. The fluidic device 100 may thus be less likely to be larger.

The first curved portion 313c1 may have, for example, a uniform width. The width of the first curved portion 313c1 may refer to, for example, the dimension of the first curved portion 313cl in a direction perpendicular to the longitudinal direction of the measurement fluidic channel 313 in the first curved portion 313cl as viewed in plan. In this case, the width of the downstream portion 311d of the main fluidic channel 311 may be substantially the same as the width W1 of the upstream portion of the first channel portion 313f1. The first curved portion 313cl may have a curvature radius of, for example, about 40 to 200 μm as viewed in plan.

This structure may reduce disturbance in the flow of the third liquid in the first curved portion 313c1. In other words, the flow of the multiple first particles P100 in the first curved portion 313cl is less likely to be disturbed. The multiple first particles P100 are thus less likely to be dense or sparse in the measurement area Am1. This can improve the accuracy in optically measuring the multiple first particles P100 flowing through the measurement fluidic channel 313 in the fluidic device 100.

For example, the first channel portion 313f1 may extend along an imaginary straight line extending in the positive X-direction as the second direction. In other words, the center line of the first channel portion 313f1 may extend, for example, in the positive X-direction as the second direction. The center line of the first channel portion 313f1 may be, for example, an imaginary line passing through the center of the cross section of the first channel portion 313f1 perpendicular to the longitudinal direction of the measurement fluidic channel 313.

This structure may reduce disturbance in the flow of the third liquid in the first channel portion 313f1. In other words, the flow of the multiple first particles P100 in the first channel portion 313f1 is less likely to be disturbed. The multiple first particles P100 are thus less likely to be dense or sparse in the measurement area Am1. This can improve the accuracy in optically measuring the multiple first particles P100 flowing through the measurement fluidic channel 313 in the fluidic device 100.

For example, the second channel portion 313f2 may extend along an imaginary straight line extending in the negative X-direction as the third direction. In other words, the center line of the second channel portion 313f2 may extend, for example, in the negative X-direction as the third direction. The center line of the second channel portion 313f2 may be, for example, an imaginary line passing through the center of the cross section of the second channel portion 313f2 perpendicular to the longitudinal direction of the measurement fluidic channel 313.

This structure may reduce disturbance in the flow of the third liquid in the second channel portion 313f2. In other words, the flow of the multiple first particles P100 in the second channel portion 313f2 is less likely to be disturbed. The multiple first particles P100 are thus less likely to be dense or sparse in the measurement area Am1. This can improve the accuracy in optically measuring the multiple first particles P100 flowing through the measurement fluidic channel 313 in the fluidic device 100.

### 1-3. Example Schematic Structure of Measurement Apparatus

FIG. 10 is a diagram of a measurement apparatus 400, illustrating an example functional structure.

As illustrated in FIGS. 2 and 10, the measurement apparatus 400 includes, for example, the fluidic device 100 and the optical sensor 4. The measurement apparatus 400 may include, for example, the fluidic device 100 attached to a body including the optical sensor 4. For example, the body including the optical sensor 4 may include multiple rod-like portions located in the multiple through-holes 11 in the fluidic device 100. In this manner, the fluidic device 100 may be attached to the body including the optical sensor 4.

The optical sensor 4 includes a light emitter 41 and a light receiver 42. In the measurement apparatus 400, each of the light emitter 41 and the light receiver 42, for example, faces the fluidic device 100. In the example in FIG. 2, each of the light emitter 41 and the light receiver 42 faces the lower surface 100b of the fluidic device 100 as the second surface.

The light emitter 41 may be a light-emitting element such as a light-emitting diode (LED) or a laser diode (LD). The light receiver 42 may be, for example, a light-receiving element such as a photodiode (PD). In this example, light emitted from the light emitter 41 passes through the third liquid in an area of the measurement fluidic channel 313 overlapping the measurement area Am1 as viewed in plan. The light is then reflected from the fluidic device 100 and received by the light receiver 42.

In FIG. 2, a thin dot-dash arrow schematically indicates a path (also referred to as a first optical path) 41r of light emitted from the light emitter 41 that enters the fluidic device 100 through the lower surface 100b of the fluidic device 100 and reaches the upper surface 100a of the fluidic device 100. In FIG. 2, a thin dot-dash arrow schematically indicates a path (also referred to as a second optical path) 42r of part of the light emitted from the light emitter 41 that is reflected at the interface between the upper surface 100a of the fluidic device 100 and reaches the light receiver 42 through the lower surface 100b of the fluidic device 100. Light emitted from the light emitter 41 and a normal to the upper surface 100a forms an angle of, for example, about 8 degrees.

The light-receiving element is, for example, an element including a semiconductor substrate of a first conductivity type that has a semiconductor region of a second conductivity type in a surface layer near its upper surface. The light-emitting element may be, for example, an element including the semiconductor substrate described above and multiple semiconductor layers stacked on the semiconductor substrate. In other words, the optical sensor 4 including the light emitter 41 and the light receiver 42 may be a light-emitting element and a light-receiving element integral with a single semiconductor substrate as described above, or may be a light-emitting element and a light-receiving element integrally fixed to a single substrate.

When the optical sensor 4 includes the light emitter 41 and the light receiver 42 integral with a single substrate, the optical sensor 4 can be smaller. The optical sensor 4 also has a shorter focal length and thus can define the measurement area Am1 accurately.

The measurement apparatus 400 may include, for example, a first feeder 5 and a second feeder 6. The first feeder 5 can feed the first liquid to the main fluidic channel 311 through the first inlet hole 321. The first feeder 5 may feed the first liquid using, for example, a pump such as a syringe pump or a plunger pump. The second feeder 6 can feed the second liquid to the main fluidic channel 311 through the second inlet hole 322. The second feeder 6 may feed the second liquid using, for example, a pump such as a syringe pump or a plunger pump.

The first feeder 5 is connected to, for example, the first inlet hole 321 in the fluidic device 100. For example, the first feeder 5 is connected to the first inlet hole 321 with a tube 5c or another member as illustrated in FIG. 10. The tube 5c includes an end with, for example, a connector connectable to the first inlet hole 321. The second feeder 6 is connected to, for example, the second inlet hole 322 in the fluidic device 100. For example, the second feeder 6 is connected to the second inlet hole 322 with a tube 6c or another member as illustrated in FIG. 10. The tube 6c includes an end with, for example, a connector connectable to the second inlet hole 322. In FIG. 10, the tubes 5c and 6c are drawn with thin two-dot-dash lines for convenience. The directions in which the first liquid and the second liquid flow in each of the tubes 5c and 6c are indicated by thin two-dot-dash arrows.

The measurement apparatus 400 may include, for example, a controller 7. The controller 7 may control, for example, the operation of components such as the optical sensor 4, the first feeder 5, and the second feeder 6. In this example, the controller 7 may be connected to each of the optical sensor 4, the first feeder 5, and the second feeder 6 to transmit and receive signals to and from each other. Signals may be transmitted and received with any method of wired communication using, for example, a cable or wireless communication.

The controller 7 may be, for example, a computer or a control circuit. The controller 7 includes at least one processor that perform control and processing for implementing various functions, as described in more detail below. At least one processor may be, for example, a single integrated circuit (IC), or multiple ICs or multiple discrete circuits, or both these circuits connected to one another for mutual communication. At least one processor may be implemented using various known techniques. The processor may include, for example, one or more circuits or units that perform one or more data computation procedures or processes by executing instructions stored in an associated memory. The processor may be a piece of firmware (e.g., a discrete logic component) to perform one or more data computation procedures or processes. The processor may include, for example, one or more processors, controllers, microprocessors, microcontrollers, application-specific integrated circuits (ASICs), digital signal processors, programmable logic devices, field programmable gate arrays, combinations of any of these devices or configurations, or combinations of other known devices and configurations. The processor may perform the functions described below. In the above example, the controller 7 includes a central processing unit (CPU) 71 and a storage 72. The storage 72 includes, for example, non-transitory recording media readable by the CPU 71, such as a read-only memory (ROM) and a random-access memory (RAM). The storage 72 may store, for example, a program Pg1 for controlling the first feeder 5, the second feeder 6, and the optical sensor 4. Various functions of the controller 7 may be implemented by the CPU 71 executing the program Pg1 in the storage 72. Note that the configuration of the controller 7 is not limited to the above example. For example, the controller 7 may include multiple CPUs 71. The controller 7 may also include at least one digital signal processor (DSP). All or at least one of the functions of the controller 7 may be implemented by a hardware circuit without involving software. The storage 72 may also include a non-transitory computer-readable recording medium other than a ROM and a RAM. The storage 72 may include, for example, a small hard disk drive or a solid-state drive (SSD), or both these drives.

When the controller 7 controls, for example, the operations of the optical sensor 4, the first feeder 5, and the second feeder 6 to feed no first liquid but the second liquid to the first upstream portion 311u of the main fluidic channel 311, the intensity (reference light intensity) P0 of light passing through the measurement area Am1 can be detected. When the controller 7 controls, for example, the operations of the optical sensor 4, the first feeder 5, and the second feeder 6 to feed the first upstream portion 311u of the main fluidic channel 311 with the first liquid and the second liquid, the intensity (measurement light intensity) P1 of light passing through the measurement area Am1 can be detected. The controller 7 can measure the concentration of the multiple first particles P100 in the third liquid based on, for example, the reference light intensity P0 and the measurement light intensity P1. More specifically, the controller 7 can calculate the concentration of the multiple first particles P100 in the third liquid based on, for example, the optical loss (in dB) resulting from the multiple first particles P100 and calculated using Formula 3 and the calibration curve indicating the relationship between the optical loss and the concentration of the multiple first particles P100.

Optical loss(dB)=−10×log₁₀(P1/P0) (3)

The calibration curve may be obtained in advance through, for example, experiments using the measurement apparatus 400. In this example, upon a change in the concentration of the multiple first particles P100 in the first liquid fed to the first upstream portion 311u of the main fluidic channel 311, the relationship between the optical loss and the concentration of the multiple first particles P100 for the third liquid collected through the first outlet hole 323 is plotted in a graph. The optical loss is calculated by the controller 7. The concentration of the multiple first particles P100 is measured by another device. This generates a scatter diagram indicating the relationship between the optical loss and the concentration of the multiple first particles P100. An arithmetic operation such as the least squares method is then performed on the scatter diagram to obtain a regression line (approximation line) as the calibration curve. The concentration of the multiple first particles P100 in the first liquid may be changed through, for example, replacement of the sample or dilution of the sample with phosphate-buffered saline (PBS).

In this example, the calibration curve may be a regression line (approximation line) for the relationship between the concentration of the multiple first particles P100 in the first liquid fed to the first upstream portion 311u and the optical loss, and the controller 7 may measure the concentration of the multiple first particles P100 in the first liquid based on the reference light intensity P0 and the measurement light intensity P1.

### 1-4. Specific Example

### 1-4-1. Relationship Between Concentration of Multiple First Particles and Optical Loss

A regression line (approximation line) as a specific example of the calibration curve is obtained through experiments using a specific example of the measurement apparatus 400 according to the first embodiment.

In this example, upon a change in the concentration of the multiple first particles P100 in the first liquid fed to the first upstream portion 311u of the main fluidic channel 311, the relationship between the optical loss and the concentration of the multiple first particles P100 for the third liquid collected through the first outlet hole 323 was plotted in a graph. The optical loss was calculated by the controller 7. The concentration of the multiple first particles P100 was measured by another device. In other words, a scatter diagram indicating the relationship between the optical loss and the concentration of the multiple first particles P100 was generated. An arithmetic operation of the least squares method was performed on the scatter diagram to obtain a regression line (approximation line) as the specific example of the calibration curve.

In the specific example of the measurement apparatus 400, the measurement fluidic channel 313 has a uniform height of about 80 μm. For the sizes of the measurement fluidic channels 313 illustrated in FIG. 5, the width of the main fluidic channel 311, the width of the first curved portion 313c1, and the width W1 were about 40 μm each. The width W2, the width of the second curved portion 313c2, and the width W3 were about 500 μm each. The width W4, the width of the third curved portion 313c3, the width W6, and the width W7 were about 1500 μm each. The distance W5 was about 100 μm. The length L1 was about 13 mm. The length L2 was about 10 mm. The length L3 was about 3 mm. The first expansion angle θ1 was 0.02 rad. The second expansion angle θ2 was 0.05 rad. The measurement area Am1 had a diameter of about 2000 μm as viewed in plan. As illustrated in FIGS. 5 and 8, the measurement area Am1 did not overlap the remaining area of the measurement fluidic channel 313 other than the third area A3 and the fourth area A4. The center of the measurement area Am1 was in an area between the third area A3 and the fourth area A4. In the measurement area Am1, the percentage of an area overlapping the third area A3 and the percentage of an area overlapping the fourth area A4 were substantially the same.

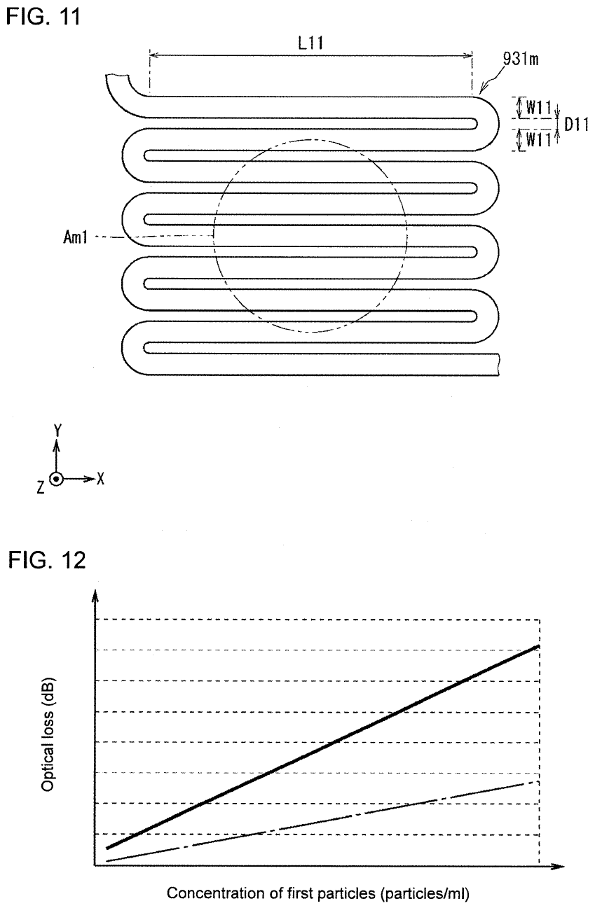

A regression line (approximation line) as a reference example of the calibration curve was obtained through experiments using a reference example of the measurement apparatus. In this example, the reference example of the measurement apparatus was a measurement apparatus based on the specific example of the measurement apparatus 400 according to the first embodiment, with the measurement fluidic channel 313 being replaced by the bending measurement fluidic channel 931m illustrated in FIG. 11. FIG. 11 is a schematic plan view of the measurement fluidic channel 931m in the reference example of the measurement apparatus.

In this example, upon a change in the concentration of the multiple first particles P100 in the first liquid fed to the first upstream portion 311u of the main fluidic channel 311, the relationship between the optical loss and the concentration of the multiple first particles P100 for the third liquid collected through an outlet hole connected to a downstream portion of the measurement fluidic channel 931m was also plotted in a graph. The optical loss was calculated by the controller 7. The concentration of the multiple first particles P100 was measured by another device. In other words, a scatter diagram indicating the relationship between the optical loss and the concentration of the multiple first particles P100 was generated. An arithmetic operation of the least squares method was performed on the scatter diagram to obtain the regression line (approximation line) as the reference example of the calibration curve.

In the reference example of the measurement apparatus, the first downstream portion 311d of the main fluidic channel 311 was 500 μm long. The first downstream portion 311d was in the shape with a width continuously increasing from about 40 μm to about 250 μm at positions farther in the negative Y-direction as the first direction. The measurement fluidic channel 931m had a uniform dimension in the positive Z-direction (also referred to as a height) of about 80 μm. The measurement fluidic channel 931m had a uniform width W11 of about 250 μm. The measurement fluidic channel 931m included a first bend, a first straight portion, a first turn portion, a second straight portion, a second turn portion, a third straight portion, a third turn portion, a fourth straight portion, a fourth turn portion, a fifth straight portion, a fifth turn portion, a sixth straight portion, a sixth turn portion, a seventh straight portion, a seventh turn portion, an eighth straight portion, an eighth turn portion, and a ninth straight portion joined together in this order. In this example, the first straight portion, the second straight portion, the third straight portion, the fourth straight portion, the fifth straight portion, the sixth straight portion, the seventh straight portion, the eighth straight portion, and the ninth straight portion were arranged in this order in the negative Y-direction with a distance D11 of about 100 μm. The first bend was an arc portion in which the fluidic channel is curved in the negative Y-direction and then in the positive X-direction. The first straight portion, the third straight portion, the fifth straight portion, the seventh straight portion, and the ninth straight portion each extended linearly in the positive X-direction. The first turn portion, the third turn portion, the fifth turn portion, and the seventh turn portion were each a semicircular arc portion in which the fluidic channel is curved in the positive X-direction and then in the negative X-direction. The second straight portion, the fourth straight portion, the sixth straight portion, and the eighth straight portion each extended linearly in the negative X-direction. The second turn portion, the fourth turn portion, the sixth turn portion, and the eighth turn portion were each a semicircular arc portion in which the fluidic channel is curved in the negative X-direction and then in the positive X-direction. The first straight portion, the second straight portion, the third straight portion, the fourth straight portion, the fifth straight portion, the sixth straight portion, the seventh straight portion, the eighth straight portion, and the ninth straight portion each had a length L11 of about 2.8 mm in the positive X-direction. The measurement area Am1 had a diameter of about 2000 μm as viewed in plan. As illustrated in FIG. 11, the measurement area Am1 extended from the second straight portion to the eighth straight portion. The center of the measurement area Am1 was substantially at the center of the fifth straight portion.

FIG. 12 is a graph showing the specific example of the calibration curve and the reference example of the calibration curve. In FIG. 12, the bold solid line indicates the specific example of the calibration curve, and the dot-dash line indicates the reference example of the calibration curve.

As shown in FIG. 12, the slope of the specific example of the calibration curve was about 2.5 times the slope of the reference example of the calibration curve. The slope indicates the degree of change in the optical loss with respect to a change in the concentration of the multiple first particles P100. In other words, for a change in the concentration of the multiple first particles P100 in the third liquid, the optical loss was greater with the specific example of the measurement apparatus 400 than with the reference example of the measurement apparatus. The specific example of the measurement apparatus 400 may thus provide an optical loss value including a smaller percentage of various noise components when the optical loss includes various noise components. The fluidic device 100 and the measurement apparatus 400 according to the first embodiment may thus improve the accuracy in optically measuring the multiple first particles P100 flowing through the fluidic channel in the fluidic device 100.

A video of the multiple first particles P100 flowing in the measurement fluidic channel 931m in the reference example of the measurement apparatus was also obtained with a digital camera. As in the example in FIG. 19, the video showed that the multiple first particles P100 were flowing in the measurement fluidic channel 931m along a side surface located in one direction perpendicular to the direction from upstream to downstream of the measurement fluidic channel 931m as viewed in plan. The percentage of the area defined by the flowing multiple first particles P100 in the measurement area Am1 was thus small as viewed in plan.

A video of the multiple first particles P100 flowing in the measurement fluidic channel 313 in the specific example of the measurement apparatus 400 was also obtained with the digital camera. As in the example in FIG. 8, the video showed that the percentage of an area defined by the flowing multiple first particles P100 in the measurement area Am1 was greater in the specific example of the measurement apparatus 400 than in the reference example of the measurement apparatus as viewed in plan.

Thus, for a change in the concentration of the multiple first particles P100 in the third liquid, the number of multiple first particles P100 in the measurement area Am1 as viewed in plan may change more greatly in the specific example of the measurement apparatus 400 than in the reference example of the measurement apparatus. The optical loss for a change in the concentration of the multiple first particles P100 in the third liquid may thus have changed more greatly with the specific example of the measurement apparatus 400 than with the reference example of the measurement apparatus.

Note that a video of the flowing multiple first particles P100 was also obtained with the digital camera for a structure based on the specific example of the measurement apparatus 400 with the first expansion angle θ1 being 0.03 rad and the second expansion angle θ2 being 0.019 rad. The percentage of an area defined by the flowing multiple first particles P100 in the measurement area Am1 as viewed in plan was also greater in this structure as illustrated in the example in FIG. 8, than in the reference example of the measurement apparatus. Videos of the flowing multiple first particles P100 were also obtained with the digital camera for structures based on the specific example of the measurement apparatus 400 with the first expansion angle θ1 being 0 rad and the second expansion angle θ2 being 0.073 rad, 0.145 rad, or 0.63 rad. In these structures, areas defined by the flowing multiple first particles P100 were not sufficiently wide in the third area A3 and in the fourth area A4 as viewed in plan. The results reveal that the width of area defined by the flowing multiple first particles P100 can be sufficiently wide when the width of the measurement fluidic channel 313 increases toward downstream of the measurement fluidic channel 313 in both the first area A1 and the second area A2.

### 1-4-2. Fluctuations in Optical Loss Based on Misalignment Between Measurement Fluidic Channel and Measurement Area

The specific example of the measurement apparatus 400 described above was used to detect the reference light intensity P0 with the optical sensor 4, with the first upstream portion 311u of the main fluidic channel 311 being fed with no first liquid but with PBS, which is the reference liquid as the second liquid. The specific example of the measurement apparatus 400 described above was used to detect the measurement light intensity P1 with the optical sensor 4, with the first upstream portion 311u of the main fluidic channel 311 being fed with the first liquid containing a uniform concentration of the multiple first particles P100 and with PBS as the second liquid.

The reference example of the measurement apparatus described above was used to detect the reference light intensity P0 with the optical sensor 4, with the first upstream portion 311u of the main fluidic channel 311 being fed with no first liquid but with PBS, which is the reference liquid as the second liquid. The reference example of the measurement apparatus as described above was used to detect the measurement light intensity P1 with the optical sensor 4, with the first upstream portion 311u of the main fluidic channel 311 being fed with the first liquid containing a uniform concentration of the multiple first particles P100 and with PBS as the second liquid.

In either the specific example of the measurement apparatus 400 or the reference example of the measurement apparatus, when the optical sensor 4 was detecting the reference light intensity P0, the optical sensor 4 was at a reference position (also referred to as a reference sensor position). When the optical sensor 4 was detecting the measurement light intensity P1, the optical sensor 4 was sequentially at the reference position (reference sensor position), a position (also referred to as a first sensor position) shifted by 100 μm from the reference sensor position in the negative Y-direction as the first direction, a position (also referred to as a second sensor position) shifted by 100 μm from the reference sensor position in the positive X-direction as the second direction, a position (also referred to as a third sensor position) shifted by 100 μm from the reference sensor position in the negative X-direction as the third direction, and a position (also referred to as a fourth sensor position) shifted by 100 μm from the reference sensor position in the positive Y-direction as the fourth direction. The measurement light intensity P1 was thus detected by the optical sensor 4.

In other words, when the optical sensor 4 was detecting the reference light intensity P0, the measurement area Am1 was at a reference position (reference position). When the optical sensor 4 was detecting the measurement light intensity P1, the measurement area Am1 was sequentially at the position of reference (also referred to as the reference position), a position (also referred to as a first position) shifted by 100 μm from the reference position in the negative Y-direction as the first direction, a position (also referred to as a second position) shifted by 100 μm from the reference position in the positive X-direction as the second direction, a position (also referred to as a third position) shifted by 100 μm from the reference position in the negative X-direction as the third direction, and a position (also referred to as a fourth position) shifted by 100 μm from the reference position in the positive Y-direction as the fourth direction. The measurement light intensity P1 was thus detected by the optical sensor 4.

In this example, the optical sensor 4 detected the reference light intensity P0 about 4000 times at intervals of 10 milliseconds while being at the reference sensor position. The optical sensor 4 detected the measurement light intensity P1 about 4000 to 7000 times at intervals of 10 milliseconds while being at each of the reference sensor position, the first sensor position, the second sensor position, the third sensor position, and the fourth sensor position.

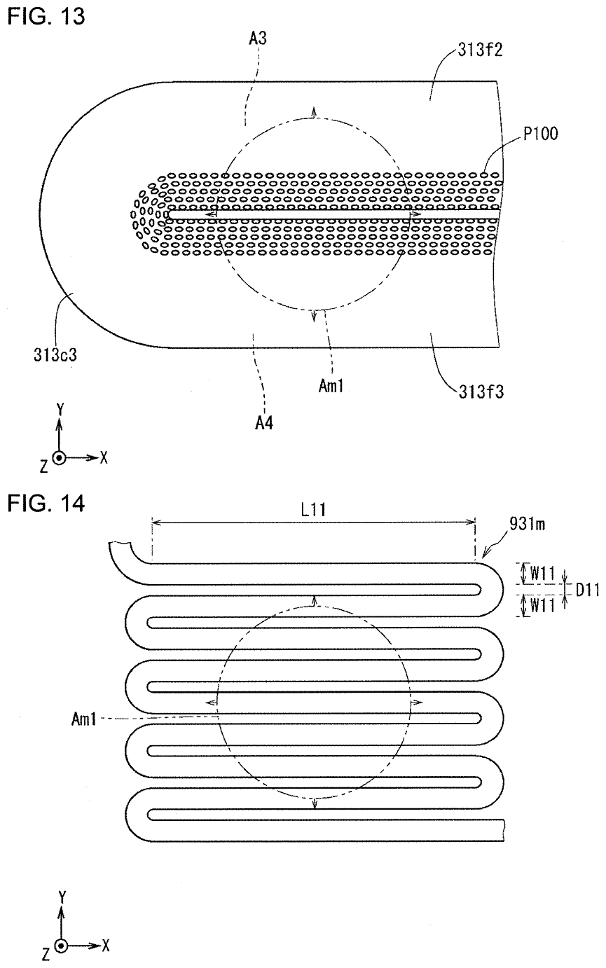

FIG. 13 is a schematic plan view illustrating the position of the measurement area Am1 defined for the measurement fluidic channel 313 in the specific example of the measurement apparatus 400. In FIG. 13, the thin two-dot-dash line schematically indicates the outer edge of the measurement area Am1 at the reference position, and the thin arrows schematically indicate the measurement area Am1 shifted in the respective four directions.

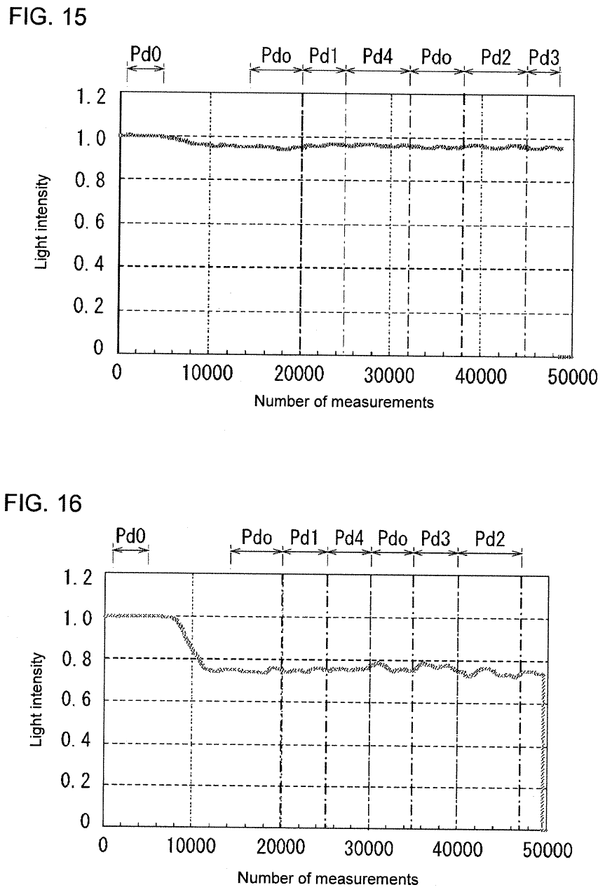

FIG. 14 is a schematic plan view illustrating the position of the measurement area Am1 defined for the measurement fluidic channel 931m in the reference example of the measurement apparatus. In FIG. 14, a thin two-dot-dash line schematically indicates the outer edge of the measurement area Am1 at the reference position, and thin arrows schematically indicate the measurement area Am1 shifted in the respective four directions.

FIG. 15 is a graph showing an example relationship between the intensity of light detected by the optical sensor 4 and the number of measurements when the reference example of the measurement apparatus is used. FIG. 16 is a graph showing an example relationship between the intensity of light detected by the optical sensor 4 and the number of measurements when the specific example of the measurement apparatus 400 was used.

In the graphs in FIGS. 15 and 16, the horizontal axis indicates the number of measurements, and the vertical axis indicates the intensity of light detected by the optical sensor 4. The relationship between the intensity of light detected by the optical sensor 4 and the number of measurements is indicated with a bold line. The light intensity on the vertical axis is indicated as light intensity values relative to the average value of light intensity during a period Pd0. The average value is set to 1.

In the graphs in FIGS. 15 and 16, the light intensity corresponding to the reference light intensity P0 detected by the optical sensor 4 at the reference sensor position is shown for the measurements in a period Pd0. In the graphs in FIGS. 15 and 16, the light intensity corresponding to the measurement light intensity P1 detected by the optical sensor 4 at the reference sensor position is shown for the measurements in a period Pdo. In the graphs in FIGS. 15 and 16, the light intensity corresponding to the measurement light intensity P1 detected by the optical sensor 4 at the first sensor position is shown for measurements in a period Pd1. In the graphs in FIGS. 15 and 16, the light intensity corresponding to the measurement light intensity P1 detected by the optical sensor 4 at the second sensor position is shown for measurements in a period Pd2. In the graphs in FIGS. 15 and 16, the light intensity corresponding to the measurement light intensity P1 detected by the optical sensor 4 at the third sensor position is shown for measurements in a period Pd3. In the graphs in FIGS. 15 and 16, the light intensity corresponding to the measurement light intensity P1 detected by the optical sensor 4 at the fourth sensor position is shown for measurements in a period Pd4.

When the reference example of the measurement apparatus is used, the reference light intensity P0 was the average value of about 4000 measurements of the reference light intensity P0 detected between about the 1000th measurement to the 5000th measurement by the optical sensor 4 at the reference sensor position. When the reference example of the measurement apparatus was used, the reference of the measurement light intensity P1 was the average value of about 6000 measurements of the measurement light intensity P1 detected between about the 14000th measurement to about the 20000th measurement by the optical sensor 4 at the reference sensor position. For the reference example of the measurement apparatus, Formula 3 described above yielded the reference of the optical loss (also referred to as the reference optical loss) of about 0.22 dB, with the value P0 being substituted with the average of the reference light intensity P0 and the value P1 being substituted with the reference of the measurement light intensity P1. For the reference example of the measurement apparatus, Formula 3 described above revealed that the optical loss fluctuated with respect to about 0.22 dB and decreased to about 0.16 dB, with the value P0 being substituted with the average of the reference light intensity P0 and the value P1 being substituted with the measurement light intensity P1 detected by the optical sensor 4 for each of the periods Pd1, Pd2, Pd3, and Pd4. In other words, when the measurement apparatus as a reference example was used, the maximum fluctuation in the optical loss was about 27% for the periods Pdo, Pd1, Pd4, Pdo, Pd2, and Pd3.

In contrast, when the specific example of the measurement apparatus 400 was used, the reference light intensity P0 was the average value of about 4000 measurements of the reference light intensity P0 detected between about the 1000th measurement to the 5000th measurement by the optical sensor 4 at the reference sensor position. When the specific example of the measurement apparatus 400 was used, the reference of the measurement light intensity P1 was the average value of about 6000 measurements of the measurement light intensity P1 detected between about the 14000th measurement to about the 20000th measurement by the optical sensor 4 at the reference sensor position. For the specific example of the measurement apparatus 400, Formula 3 described above yielded the reference of the optical loss (reference optical loss) of about 1.27 dB, with the value P0 being substituted with the average of the reference light intensity P0 and the value P1 being substituted with the reference of the measurement light intensity P1. For the specific example of the measurement apparatus 400, with the value P0 being substituted with the average of the reference light intensity P0 and the P1 being substituted with the measurement light intensity P1 detected by the optical sensor 4 during each of the periods Pd1, Pd2, Pd3, and Pd4, Formula 3 described above revealed that the optical loss fluctuated with respect to about 1.27 dB and decreased to about 1.12 dB. In other words, when the specific example of the measurement apparatus 400 was used, the maximum fluctuation in the optical loss was about 12% for the periods Pdo, Pd1, Pd4, Pdo, Pd2, and Pd3.

The specific example of the measurement apparatus 400 thus had smaller optical loss fluctuations than the reference example of the measurement apparatus when the measurement fluidic channel 313 or 931m and the measurement area Am1 were misaligned. This result may be obtained because the reference optical loss was several times greater with the specific example of the measurement apparatus 400 than with the reference example of the measurement apparatus and thus the noise components resulting from the misalignment between the measurement fluidic channel 313 or 931m and the measurement area Am1 constituted a smaller proportion of the optical loss. In other words, the above results may be obtained because the misalignment between the measurement fluidic channel 313 and the measurement area Am1 caused a smaller rate of decrease in the percentage of the area defined by the flowing multiple first particles P100 in the measurement area Am1 as viewed in plan for the specific example of the measurement apparatus 400 than for the reference example of the measurement apparatus. The observation above also reveals that the fluidic device 100 and the measurement apparatus 400 according to the first embodiment may have improved accuracy in optically measuring the multiple first particles P100 flowing through the fluidic channel in the fluidic device 100.

### 1-5. Overview of First Embodiment

The fluidic device 100 according to the first embodiment includes the main fluidic channel 311 as the first fluidic channel, the multiple branch fluidic channels 312 as the multiple second fluidic channels, and the measurement fluidic channel 313 as the third fluidic channel. The main fluidic channel 311 extends in the negative Y-direction as the first direction. The multiple branch fluidic channels 312 are each narrower than the main fluidic channel 311 and open in the side surface (first side surface) of the main fluidic channel 311 located in the positive X-direction as the second direction between the first upstream portion 311u and the first downstream portion 311d. The measurement fluidic channel 313 is connected to the first downstream portion 311d of the main fluidic channel 311. The measurement fluidic channel 313 includes the first curved portion 313c1, the first channel portion 313f1, the second curved portion 313c2, the second channel portion 313f2, the third curved portion 313c3, and the third channel portion 313f3. The first curved portion 313c1 is an arc portion that connects the first downstream portion 311d of the main fluidic channel 311 and the upstream portion of the first channel portion 313f1 and is curved in the negative Y-direction as the first direction and then in the positive X-direction as the second direction. The first channel portion 313f1 extends in the positive X-direction as the second direction. The second curved portion 313c2 is a semicircular arc portion that connects the downstream portion of the first channel portion 313f1 and the upstream portion of the second channel portion 313f2 and is curved in the positive X-direction as the second direction and then in the negative X-direction as the third direction. The second channel portion 313f2 is located opposite to the multiple branch fluidic channels 312 from the first channel portion 313f1 and extends in the negative X-direction as the third direction. The third curved portion 313c3 is a semicircular arc portion that connects the downstream portion of the second channel portion 313f2 and the upstream portion of the third channel portion 313f3 and is curved in the negative X-direction as the third direction and then in the positive X-direction as the second direction. The third channel portion 313f3 is located opposite to the first channel portion 313f1 from the second channel portion 313f2 and extends in the positive X-direction as the second direction. The first channel portion 313f1 includes the first area A1 that is wider at positions farther in the positive X-direction as the second direction. The second channel portion 313f2 includes the second area A2 and the third area A3. The second area A2 is wider at positions farther in the negative X-direction as the third direction. The third area A3 is located between the second area A2 and the third curved portion 313c3. The third channel portion 313f3 includes the fourth area A4. The fourth area A4 extends along the third area A3.

In this structure, the measurement fluidic channel 313 includes the first channel portion 313f1 and the second channel portion 313f2 each being wider toward the downstream portion. The measurement fluidic channel 313 can thus be gradually wider. This structure may reduce disturbance in the flow of the third liquid containing multiple first particles P100 in the measurement fluidic channel 313. In the first area A1 of the first channel portion 313f1, an area defined by the multiple first particles P100 flowing along the side surface (third side surface) of the first channel portion 313f1 located in the positive Y-direction as the fourth direction may be gradually wider as the width of the first channel portion 313f1 increases gradually. In the second area A2 of the second channel portion 313f2, the area defined by the multiple first particles P100 flowing along the side surface (fourth side surface) of the second channel portion 313f2 located in the negative Y-direction as the first direction may be gradually wider toward the third area A3 as the width of the second channel portion 313f2 increases gradually. In the third channel portion 313f3, an area defined by the multiple first particles P100 flowing along the side surface (fifth side surface) located in the positive Y-direction as the fourth direction and extending along the second channel portion 313f2 may have a width substantially the same as or larger than the increased width of the area defined by the multiple first particles P100 flowing in the second channel portion 313f2.

An area for the optical sensor 4 to measure the multiple first particles P100, or the measurement area Am1, may be defined to overlap an area extending from the third area A3 to the fourth area A4 as viewed in plan. In this case, the measurement area Am1 may include the multiple first particles P100 in the third area A3 flowing along the side surface (fourth side surface) adjacent to the fourth area A4 while spreading about the fifth width Wd5 wide, and the multiple first particles P100 in the fourth area A4 flowing along the side surface (fifth side surface) adjacent to the third area A3 while spreading about the sixth width Wd6 wide. The area defined by the flowing multiple first particles P100 in the measurement fluidic channel 313 may account for a larger percentage in the measurement area Am1 as viewed in plan. The number of multiple first particles P100 in the area overlapping the measurement area Am1 as viewed in plan may thus change greatly based on a change in the concentration of the multiple first particles P100 in the third liquid. In other words, the optical sensor 4 may have a higher sensitivity in measuring the concentration of the multiple first particles P100. This can improve the accuracy in optically measuring the multiple first particles P100 flowing through the measurement fluidic channel 313 in the fluidic device 100.

Additionally, misalignment between the measurement fluidic channel 313 and the measurement area Am1 may cause a smaller decrease in the percentage of the area defined by the flowing multiple first particles P100 in the measurement area Am1. This can improve the accuracy in optically measuring the multiple first particles P100 flowing through the measurement fluidic channel 313 in the fluidic device 100.

The measurement apparatus 400 according to the first embodiment includes the fluidic device 100 and the optical sensor 4. The optical sensor 4 includes the light emitter 41 and the light receiver 42. Each of the light emitter 41 and the light receiver 42 faces the fluidic device 100. This structure can also improve the accuracy in optically measuring the multiple first particles P100 flowing through the measurement fluidic channel 313 in the fluidic device

### 2. Other Embodiments

The present disclosure is not limited to the first embodiment described above and may be changed or varied in various manners without departing from the spirit and scope of the present disclosure.

### 3. Other Embodiments

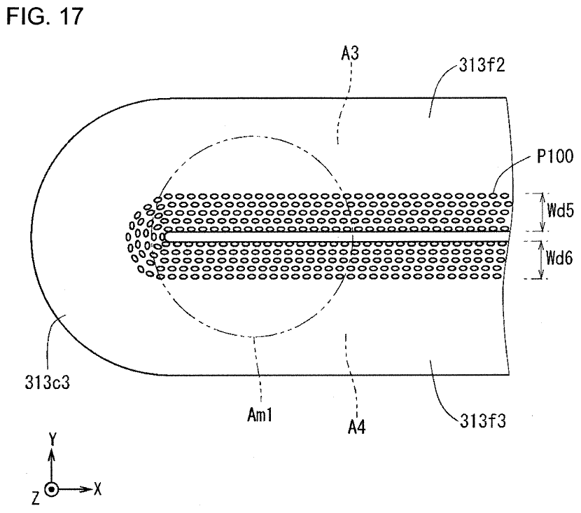

In the first embodiment, the measurement area Am1 may partially overlap the third curved portion 313c3 as viewed in plan as illustrated in FIG. 17, for example. In other words, the measurement area Am1 for the optical sensor 4 may, for example, overlap an area extending from the third area A3 to the fourth area A4 as viewed in plan. When the measurement area Am1 does not overlap the remaining area of the measurement fluidic channel 313 other than the third area A3 and the fourth area A4 as viewed in plan, for example, misalignment between the measurement fluidic channel 313 and the measurement area Am1 may cause a smaller decrease in the percentage of an area defined by flowing multiple first particles P100 in the measurement area Am1. This can improve the accuracy in optically measuring the multiple first particles P100 flowing through the measurement fluidic channel 313 in the fluidic device 100.

In the first embodiment, the first area A1 is wider in the negative Y-direction as the first direction and in the positive Y-direction as the fourth direction at positions farther in the positive X-direction as the second direction. However, the first area A1 may have any other structure. For example, the first area A1 may be wider in the negative Y-direction as the first direction or in the positive Y-direction as the fourth direction at positions farther in the positive X-direction as the second direction. In other words, the first area A1 may be, for example, wider in at least one of the negative Y-direction as the first direction or the positive Y-direction as the fourth direction at positions farther in the positive X-direction as the second direction.

In the first embodiment, the second area A2 is wider in the negative Y-direction as the first direction and in the positive Y-direction as the fourth direction at positions farther in the negative X-direction as the third direction. However, the second area A2 may have any other structure. For example, the second area A2 may be wider in the negative Y-direction as the first direction or in the positive Y-direction as the fourth direction at positions farther in the negative X-direction as the third direction. In other words, the second area A2 may be, for example, wider in at least one of the negative Y-direction as the first direction or the positive Y-direction as the fourth direction at positions farther in the negative X-direction as the third direction.

In the above first embodiment, the fluidic device 100 may include, for example, a film- or plate-like reflector attached along the upper surface 100a. In other words, the fluidic device 100 may include, for example, a film- or plate-like reflector located along the upper surface 100a. In this case, a metal film may be formed on the upper surface 100a by, for example, vapor deposition or sputtering to form a film-like reflector along the upper surface 100a. A plate of a reflector may be fixed on the upper surface 100a with, for example, an adhesive or adhesive tape to form a plate-like reflector along the upper surface 100a. The reflector may be a part of the upper surface 100a or may be located on the upper surface 100a.

In the first embodiment described above, the fluidic device 100 may include, for example, a film or plate-like non-reflector attached along the upper surface 100a. In other words, the fluidic device 100 may, for example, include a film- or plate-like non-reflector located along the upper surface 100a. In this case, a piece of non-reflective cloth may be fixed on the upper surface 100a with, for example, an adhesive or adhesive tape to form a plate-like non-reflector along the upper surface 100a. For example, a black resin may be applied to the upper surface 100a to form a film-like non-reflector along the upper surface 100a. The non-reflector may be a part of the upper surface 100a or may be located on the upper surface 100a.

In the first embodiment, each of the light emitter 41 and the light receiver 42 faces the lower surface 100b of the fluidic device 100. However, the light emitter 41 and the light receiver 42 may have any other structure. For example, the light emitter 41 and the light receiver 42 may be located with the fluidic device 100 between them. For example, the light emitter 41 may face the lower surface 100b of the fluidic device 100, and the light receiver 42 may face the upper surface 100a of the fluidic device 100. For example, the light emitter 41 may face the upper surface 100a of the fluidic device 100, and the light receiver 42 may face the lower surface 100b of the fluidic device 100. In this case, light emitted from the light emitter 41 may, for example, pass through the third liquid within an area of the measurement fluidic channel 313 overlapping the measurement area Am1 as viewed in plan, through the fluidic device 100, and then be received by the light receiver 42.

In the first embodiment, the calibration curve is a regression line (approximation line) obtained by performing operations including the least squares method on a scatter diagram indicating the relationship between the optical loss and the concentration of the multiple first particles P100. However, the calibration curve is not limited to this example. The calibration curve may not be a linear function, for example, and may be an approximation curve obtained by performing operations on a scatter diagram indicating the relationship between the optical loss and the concentration of the multiple first particles P100. The approximation curve may be, for example, a quadratic function. In the first embodiment, optical measurement is performed for the concentration of multiple particles of a specific type. However, measurement may be performed on any other target. Optical measurement may be performed for, for example, the distribution of multiple particles of a specific type or the variation in sizes or shapes of multiple particles of a specific type. Optical measurement may be performed to measure the amount (number) of multiple particles of a specific type based on, for example, the product of the concentration of multiple particles of the specific type in the third liquid and the measurement time.

In the first embodiment described above, the second curved portion 313c2 having a large curvature radius as viewed in plan may, for example, reduce disturbance in the flow of the multiple first particles P100 in the second curved portion 313c2. Thus, the width of the second curved portion 313c2 may increase slightly toward the second channel portion 313f2 based on, for example, the curvature radius of the second curved portion 313c2 as viewed in plan.

In the first embodiment described above, the first curved portion 313c1 having a large curvature radius as viewed in plan may reduce, for example, disturbance in the flow of the multiple first particles P100 in the first curved portion 313c1. Thus, the width of the first curved portion 313c1 may increase slightly toward the first channel portion 313f1 based on, for example, the curvature radius of the first curved portion 313c1 as viewed in plan.

In the first embodiment described above, each of the first channel portion 313f1 and the third channel portion 313f3 as viewed in plan may include, for example, a slightly curved portion or a slightly bending portion within a portion extending in the positive X-direction as the second direction. In other words, each of the first channel portion 313f1 and the third channel portion 313f3 as viewed in plan may include, for example, a slightly curved portion or a slightly meandering portion in a range with which the flow of the third liquid is not disturbed substantially, for example.

In the first embodiment described above, the second channel portion 313f2 as viewed in plan may include, for example, a slightly curved portion or a slightly bending portion within a portion extending in the negative X-direction as the third direction. In other words, the second channel portion 313f2 as viewed in plan may include, for example, a slightly curved portion or a slightly bending portion in a range with which the flow of the third liquid is not disturbed substantially.

In the first embodiment described above, the third channel portion 313f3 may be smaller with the width W7 of the downstream portion of the third channel portion 313f3 being smaller than the width W6 of the upstream portion of the third channel portion 313f3. This structure may reduce the size of the fluidic device 100. The third channel portion 313f3 may have, for example, a substantially uniform width to reduce disturbance in the flow of the third liquid in the measurement fluidic channel 313. In other words, the third channel portion 313f3 having, for example, a substantially uniform width may reduce disturbances in the flow of the multiple first particles P100 in the measurement fluidic channel 313.

In the first embodiment described above, the fluidic device 100 includes a single set of first inlet hole 321 and first introduction fluidic channel 314 as a first introduction unit for introducing the first liquid into the main fluidic channel 311. However, the fluidic device 100 may have any other structure. For example, the fluidic device 100 may include two or more sets of first inlet holes 321 and first introduction fluidic channels 314 as two or more first introduction units. Each of the first introduction units may be appropriately connected to the main fluidic channel 311 to implement the functions of the sorting fluidic channel 31s.

In the first embodiment described above, the fluidic device 100 includes a single set of second inlet hole 322 and second introduction fluidic channel 315 as a second introduction unit for introducing the second liquid into the main fluidic channel 311. However, the fluidic device 100 may have any other structure. For example, the fluidic device 100 may include two or more sets of second inlet holes 322 and second introduction fluidic channels 315 as two or more second introduction units. Each of the second introduction units may be appropriately connected to the main fluidic channel 311 to implement the functions of the sorting fluidic channel 31s.

In the first embodiment described above, each of the multiple holes 32 may be, for example, open in either the upper surface 100a or the lower surface 100b of the fluidic device 100.

In the first embodiment described above, each of the first introduction fluidic channel 314 and the second introduction fluidic channel 315 may not have a uniform width from upstream to downstream. For example, the first introduction fluidic channel 314 may include a portion that is narrower in a continuous or a stepwise manner from the first inlet hole 321 to the main fluidic channel 311. For example, the second introduction fluidic channel 315 may include a portion that is narrower in a continuous or a stepwise manner from the second inlet hole 322 to the main fluidic channel 311. For example, the first discharge fluidic channel 316 may include a portion that is wider in a continuous or a stepwise manner toward the second outlet hole 324.

In the first embodiment described above, the fluidic channel section 31 may further include, for example, a fluidic channel (also referred to as a second discharge fluidic channel) connected to the first downstream portion 311d. The multiple holes 32 may include a hole (also referred to as a third outlet hole) connected to the downstream portion of the second discharge fluidic channel opposite to the upstream portion connected to the first downstream portion 311d. The upstream portion of the second discharge fluidic channel may extend, for example, in the negative X-direction as the third direction. The remaining component of the first liquid other than the multiple first particles P100 and the multiple second particles P200 may be discharged as appropriate from the first downstream portion 311d of the main fluidic channel 311 through the second discharge fluidic channel and the third outlet hole. The second discharge fluidic channel may include, for example, a portion that is wider in a continuous or a stepwise manner from the main fluidic channel 311 toward the third outlet hole.

In the first embodiment described above, the first plate portion 1 may be made of, for example, a resin such as cycloolefin polymer (COP) or an acrylic resin. The acrylic resin may be, for example, polymethyl methacrylate (PMMA).

In the first embodiment described above, when the first plate portion 1 and the third plate portion 3 can be easily bonded directly to each other, the fluidic device 100 may include the first plate portion 1 and the third plate portion 3 bonded directly to each other without including the second plate portion 2. In this case, the first lower surface 1b of the first plate portion 1 may cover the third upper surface 3a of the third plate portion 3 with fine protrusions and recesses corresponding to the pattern of the fluidic channel section 31, for example. The first lower surface 1b and the third upper surface 3a may thus be bonded together to form the fluidic channel section 31. The first lower surface 1b and the third upper surface 3a may be bonded together without an adhesive by, for example, modifying each of the first lower surface 1b of the first plate portion 1 and the third upper surface 3a of the third plate portion 3 and causing the first lower surface 1b and the third upper surface 3a to come in contact with each other. The surface modification may be performed by, for example, irradiation of oxygen plasma or irradiation of ultraviolet (UV) light using an excimer lamp.

In the first embodiment described above, the first liquid may be, for example, a liquid containing multiple types of particles other than blood. In this case, the second liquid may be, for example, any of various liquids corresponding to the first liquid. The various liquids may include, for example, water.

As described above, the fluidic device and the measurement apparatus have been described in detail, but the above structures are illustrative in all respects, and the disclosure is not limited to the above structures. The above embodiments may be combined in any manner unless any contradiction arises. Examples other than those illustrated above may also be included without departing from the scope of the disclosure.

The present disclosure provides the structures described below.

In one embodiment, (1) a fluidic device includes a fluidic channel section unopen in an outer surface of the fluidic device, and a plurality of holes each being continuous with the fluidic channel section and each being open in the outer surface. The fluidic channel section includes a first fluidic channel, a plurality of second fluidic channels each being connected to the first fluidic channel and each being narrower than the first fluidic channel, a third fluidic channel connected to a first downstream portion of the first fluidic channel, a fourth fluidic channel connected to a first upstream portion of the first fluidic channel, and a fifth fluidic channel connected to the first upstream portion. The plurality of holes includes a first inlet hole connected to the fourth fluidic channel, a second inlet hole connected to the fifth fluidic channel, a first outlet hole being continuous with a second downstream portion of the third fluidic channel, and a second outlet hole being continuous with a third downstream portion of each of the plurality of second fluidic channels. The third downstream portion is opposite to the first fluidic channel. The first fluidic channel extends in a first direction. Each of the plurality of second fluidic channels is open in a side surface of the first fluidic channel, and the side surface is located in a second direction perpendicular to the first direction between the first upstream portion and the first downstream portion. The fourth fluidic channel includes a first connection connected to the first upstream portion and extending in the first direction. The fifth fluidic channel includes a second connection connected to the first upstream portion and being open in a side surface of the first upstream portion. The side surface of the first upstream portion is located in the third direction opposite to the second direction. The third fluidic channel includes a first channel portion extending in the second direction, a second channel portion located opposite to the plurality of second fluidic channels from the first channel portion and extending in the third direction, a third channel portion located opposite to the first channel portion from the second channel portion and extending in the second direction, a first curved portion being an arc portion connecting the first downstream portion and an upstream portion of the first channel portion and curved in the first direction and in the second direction, a second curved portion being a semicircular arc portion connecting a downstream portion of the first channel portion and an upstream portion of the second channel portion and curved in the second direction and in the third direction, and a third curved portion being a semicircular arc portion connecting a downstream portion of the second channel portion and an upstream portion of the third channel portion and curved in the third direction and in the second direction. The first channel portion includes a first area being wider at positions farther in the second direction. The second channel portion includes a second area being wider at positions farther in the third direction and a third area located between the second area and the third curved portion. The third channel portion includes a fourth area located along the third area.

(2) In the fluidic device according to (1), the second curved portion may have a uniform width.

(3) In the fluidic device according to (1) or (2), the first channel portion may extend along an imaginary straight line extending in the second direction.

(4) In the fluidic device according to any one of (1) to (3), the second channel portion may extend along an imaginary straight line extending in the third direction.

(5) In the fluidic device according to any one (1) to (4), the first channel portion may be wider with a first expansion rate greater than a second expansion rate with which the second channel portion is wider.

(6) In the fluidic device according to any one of (1) to (5), the first inlet hole may allow introduction of a first liquid containing a plurality of types of particles including a plurality of first particles and a plurality of second particles into the first fluidic channel. Each of the plurality of first particles may have a diameter larger than a width of each of the plurality of second fluidic channels. Each of the plurality of second particles may have a diameter smaller than the width of each of the plurality of second fluidic channels. The second inlet hole may allow introduction of a second liquid into the first fluidic channel. The second liquid in the first fluidic channel may push the plurality of types of particles against a side surface of the first fluidic channel located in the second direction in the first fluidic channel.

(7) In the fluidic device according to any one of (1) to (6), a measurement area for an optical sensor may overlap an area extending from the third area to the fourth area.

(8) In the fluidic device according to (7), the measurement area may not overlap an area of the third fluidic channel other than the third area and the fourth area.

(9) A measurement apparatus includes the fluidic device according to (7) or (8), and the optical sensor. The optical sensor includes a light emitter facing the fluidic device and a light receiver facing the fluidic device.

(10) In the measurement apparatus according to (9), the fluidic device may include a first surface and a second surface opposite to the first surface. Each of the light emitter and the light receiver may face the second surface.

1.-10. (canceled)

11. A fluidic device, comprising:
a first fluidic channel including a first upstream portion and a first downstream portion, the first fluidic channel extending in a first direction;
a plurality of second fluidic channels connected to a surface of the first fluidic channel between the first upstream portion and the first downstream portion, the surface being located in a second direction intersecting the first direction in the first fluidic channel;
a third fluidic channel connected to the first downstream portion;
a fourth fluidic channel connected to the first upstream portion;
a fifth fluidic channel connected to the first upstream portion; and
a first outlet hole connected to a second downstream portion of the third fluidic channel, wherein
the first fluidic channel, the plurality of second fluidic channels, the third fluidic channel, the fourth fluidic channel, and the fifth fluidic channel are formed between two plate-like portions, and
the third fluidic channel includes one or more wide portions between a portion connected to the first downstream portion and the second downstream portion.

12. The fluidic device according to claim 11, wherein
each of the one or more wide portions is a portion being wider from upstream to downstream.

13. The fluidic device according to claim 11, wherein
each of the one or more wide portions includes a portion wider than the portion connected to the first downstream portion in the third fluidic channel.

14. The fluidic device according to claim 11, wherein
the third fluidic channel includes:
a first curved portion whose channel direction is changed from the first direction to the second direction; and
a first channel portion connected to the first curved portion and extending in the second direction, and
the first channel portion includes a first wide portion of the one or more wide portions.

15. The fluidic device according to claim 14, wherein
the third fluidic channel includes:
a second curved portion whose channel direction is changed from the second direction to a third direction opposite to the second direction, the second curved portion being connected to the first channel portion; and
a second channel portion connected to the second curved portion and extending in the third direction, and
the second channel portion includes a second wide portion of the one or more wide portions.

16. The fluidic device according to claim 15, wherein
the first wide portion is wider with an expansion rate greater than an expansion rate with which the second wide portion is wider.

17. The fluidic device according to claim 11, wherein
the third fluidic channel includes a portion located on a third direction side opposite to the second direction with respect to the first fluidic channel.

18. The fluidic device according to claim 11, wherein
the first outlet hole has a diameter greater than or equal to a width of the second downstream portion.

19. The fluidic device according to claim 11, wherein
the third fluidic channel in a channel direction is longer than the first fluidic channel in a channel direction.

20. The fluidic device according to claim 11, wherein
the third fluidic channel in a channel direction is longer than the fourth fluidic channel in a channel direction.

21. The fluidic device according to claim 11, wherein
a maximum width of the third fluidic channel is greater than a maximum width of the fifth fluidic channel.

22. The fluidic device according to claim 11, wherein
the first outlet hole is located on a second direction side in the second direction with respect to the first fluidic channel.
